(19) United States
(12) Patent Application Publication
(10) Pub. No.: US 2021/0356565 A1
(43) Pub. Date: Nov. 18, 2021

(54) OPTICAL DEVICE

(71) Applicant: Panasonic Intellectual Property Management Co., Ltd., Osaka (JP)

(72) Inventors: MASAHIKO TSUKUDA, Osaka (JP); TAKAIKI NOMURA, Osaka (JP); YASUHISA INADA, Osaka (JP)

(21) Appl. No.: 17/391,051

(22) Filed: Aug. 2, 2021

Related U.S. Application Data
(63) Continuation of application No. PCT/JP2019/050336, filed on Dec. 23, 2019.

(30) Foreign Application Priority Data
Feb. 18, 2019 (JP) 2019-026288

(51) Int. Cl. G01S 7/481; G02F 1/13; G02F 1/1343; G02F 1/133; G02F 1/1335

(52) U.S. Cl. CPC G01S 7/4817; G02F 1/1326; G01S 17/89; G02F 1/13306; G02F 1/133553; G02F 1/134309

(57) ABSTRACT

An optical device includes: a first mirror having translucency and including a first reflecting surface extending along a first direction and a second direction intersecting the first direction; a second mirror including a second reflecting surface facing the first reflecting surface; an optical waveguide layer located between the first mirror and the second mirror, the optical waveguide layer including a plurality of non-waveguide areas laid side-by-side along the second direction and one or more optical waveguide areas located between the plurality of non-waveguide areas, the optical waveguide areas containing a liquid crystal material, having a higher average refractive index than do the plurality of non-waveguide areas, and propagating light along the first direction; and two electrode layers facing each other across the optical waveguide layer, at least one of the two electrode layers including a plurality of electrodes laid side-by-side along the second direction.

### BACKGROUND

### 1. Technical Field

The present disclosure relates to an optical device.

### 2. Description of the Related Art

There have conventionally been proposed various types of device that are capable of scanning space with light.

International Publication No. 2013/168266 discloses a configuration in which an optical scan can be performed with a mirror-rotating driving apparatus.

Japanese Unexamined Patent Application Publication (Translation of PCT Application) No. 2016-508235 discloses an optical phased array having a plurality of two-dimensionally arrayed nanophotonic antenna elements. Each antenna element is optically coupled to a variable optical delay line (i.e. a phase shifter). In this optical phased array, a coherent light beam is guided to each antenna element by a waveguide, and the phase of the light beam is shifted by the phase shifter. This makes it possible to vary the amplitude distribution of a far-field radiating pattern.

Japanese Unexamined Patent Application Publication No. 2013-16591 discloses an optical deflection element including: a waveguide including an optical waveguide layer through the inside of which light is guided and first distributed Bragg reflectors formed on upper and lower surfaces, respectively, of the optical waveguide layer; a light entrance through which light enters the waveguide, and a light exit formed on a surface of the waveguide to let out light having entered through the light entrance and being guided through the inside of the waveguide.

### SUMMARY

One non-limiting and exemplary embodiment provides a novel optical device of a comparatively simple configuration.

In one general aspect, the techniques disclosed here feature an optical device including: a first mirror having translucency and including a first reflecting surface extending along a first direction and a second direction intersecting the first direction; a second mirror including a second reflecting surface facing the first reflecting surface; an optical waveguide layer located between the first mirror and the second mirror, the optical waveguide layer including a plurality of non-waveguide areas laid side-by-side along the second direction and one or more optical waveguide areas located between the plurality of non-waveguide areas, the optical waveguide areas containing a liquid crystal material and propagating light along the first direction; and two electrode layers facing each other across the optical waveguide layer, at least one of the two electrode layers including a plurality of electrodes laid side-by-side along the second direction, wherein the plurality of electrodes include an electrode overlapping at least a part of the plurality of non-waveguide areas when seen from an angle parallel with a direction perpendicular to the first reflecting surface or the second reflecting surface.

An aspect of the present disclosure makes it possible to achieve a comparatively simple configuration.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a perspective view schematically showing a configuration of an optical scan device according to an exemplary embodiment of the present disclosure;

FIG. 2 is a diagram schematically showing an example of a cross-section structure of one waveguide element and an example of propagating light;

FIG. 3A is a diagram showing a cross-section of a waveguide array that emits light in a direction perpendicular to an exit face of the waveguide array;

FIG. 3B is a diagram showing a cross-section of a waveguide array that emits light in a direction different from a direction perpendicular to an exit face of the waveguide array;

FIG. 4 is a perspective view schematically showing a waveguide array in a three-dimensional space;

FIG. 5 is a schematic view of a waveguide array and a phase shifter array as seen from a direction (Z direction) normal to a light exit face;

FIG. 6A is a perspective view of an optical device according to an exemplary embodiment of the present disclosure;

FIG. 6B is a cross-sectional view of the optical device shown in FIG. 6A as taken along a Y-Z plane;

FIG. 7A is a diagram schematically showing a first state in which a liquid crystal material is oriented in a Y direction in the example shown in FIG. 6B;

FIG. 7B is a diagram schematically showing a second state in which the liquid crystal material is oriented in a Z direction in the example shown in FIG. 6B;

FIG. 8A is a perspective view of an optical device according to an exemplary embodiment of the present disclosure;

FIG. 8B is a cross-sectional view of the optical device shown in FIG. 8A as taken along the Y-Z plane;

FIG. 9A is a diagram schematically showing a first state in which a liquid crystal material is oriented in the Y direction in the example shown in FIG. 8B;

FIG. 9B is a diagram schematically showing a second state in which the liquid crystal material is oriented in the Z direction in the example shown in FIG. 8B;

FIG. 10A is a perspective view of an optical device according to an exemplary embodiment of the present disclosure;

FIG. 10B is a cross-sectional view of the optical device shown in FIG. 10A as taken along the Y-Z plane;

FIG. 11A is a diagram schematically showing a first state in which a liquid crystal material is oriented in the Y direction in the example shown in FIG. 10B;

FIG. 11B is a diagram schematically showing a second state in which the liquid crystal material is oriented in the Z direction in the example shown in FIG. 10B;

FIG. 11C is a diagram schematically showing the second state in which the liquid crystal material is oriented in the Z direction in the example shown in FIG. 10B;

FIG. 12A is a perspective view of an optical device according to an exemplary embodiment of the present disclosure;

FIG. 12B is a cross-sectional view of the optical device shown in FIG. 12A as taken along the Y-Z plane;

FIG. 13A is a diagram schematically showing a first state in which a liquid crystal material is oriented in the Y direction in the example shown in FIG. 12B;

FIG. 13B is a diagram schematically showing a second state in which the liquid crystal material is oriented in the Z direction in the example shown in FIG. 12B;

FIG. 13C is a diagram schematically showing the second state in which the liquid crystal material is oriented in the Z direction in the example shown in FIG. 12B;

FIG. 14A is a perspective view of an optical device according to an exemplary embodiment of the present disclosure;

FIG. 14B is a cross-sectional view of the optical device shown in FIG. 14A as taken along the Y-Z plane;

FIG. 15A is a perspective view of an optical device according to an exemplary embodiment of the present disclosure;

FIG. 15B is a cross-sectional view of the optical device shown in FIG. 15A as taken along the Y-Z plane;

FIG. 16 is a diagram showing an example configuration of an optical scan device in which elements such as an optical divider, a waveguide array, a phase shifter array, and a light source are integrated on a circuit board;

FIG. 17 is a schematic view showing how a two-dimensional scan is being executed by irradiating a distant place with a light beam such as a laser from the optical scan device; and

FIG. 18 is a block diagram showing an example configuration of a LiDAR system that is capable of generating a ranging image.

### DETAILED DESCRIPTION

Prior to a description of embodiments of the present disclosure, underlying knowledge forming the basis of the present disclosure is described.

The inventors found that a conventional optical scan device has difficulty in scanning space with light without making a complex apparatus configuration.

For example, the technology disclosed in International Publication No. 2013/168266 requires a mirror-rotating driving apparatus. This undesirably makes a complex apparatus configuration that is not robust against vibration.

In the optical phased array described in Japanese Unexamined Patent Application Publication (Translation of PCT Application) No. 2016-508235, it is necessary to divide light into lights, introduce the lights into a plurality of column waveguide and a plurality of row waveguides, and guide the lights to the plurality of two-dimensionally arrayed antenna elements. This results in very complex wiring of waveguides through which to guide the lights. This also makes it impossible to attain a great two-dimensional scanning range. Furthermore, to two-dimensionally vary the amplitude distribution of emitted light in a far field, it is necessary to connect phase shifters separately to each of the plurality of two-dimensionally arrayed antenna elements and attach phase-controlling wires to the phase shifters. This causes the phases of lights falling on the plurality of two-dimensionally arrayed antenna elements to vary by a different amount. This makes the elements very complex in configuration.

The inventors focused on the foregoing problems in the conventional technologies and studied configurations to solve these problems. The inventors found that the foregoing problems can be solved by using a waveguide element having a pair of mirrors facing each other and an optical waveguide layer sandwiched between the mirrors. One of the pair of mirrors of the waveguide element has a higher light transmittance than the other and lets out a portion of light propagating through the optical waveguide layer. As will be mentioned later, the direction of light emitted (or the angle of emission) can be changed by adjusting the refractive index or thickness of the optical waveguide layer or the wavelength of light that is inputted to the optical waveguide layer. More specifically, by changing the refractive index, the thickness, or the wavelength, a component constituting the wave number vector (wave vector) of the emitted light and acting in a direction along a lengthwise direction of the optical waveguide layer can be changed. This allows a one-dimensional scan to be achieved.

Furthermore, in a case where an array of a plurality of the waveguide elements is used, a two-dimensional scan can be achieved. More specifically, a direction in which lights going out from the plurality of waveguide elements reinforce each other can be changed by giving an appropriate phase difference to lights that are supplied to the plurality of waveguide elements and adjusting the phase difference. A change in phase difference brings about a change in a component constituting the wave number vector of the emitted light and acting in a direction that intersects the direction along the lengthwise direction of the optical waveguide layer. This makes it possible to achieve a two-dimensional scan. Even in a case where a two-dimensional scan is performed, it is not necessary to cause the refractive index or thickness of each of a plurality of the optical waveguide layers or the wavelength of light to vary by a different amount. That is, a two-dimensional scan can be performed by giving an appropriate phase difference to lights that are supplied to the plurality of optical waveguide layers and causing at least one of the refractive index of each of the plurality of optical waveguide layers, the thickness of each of the plurality of optical waveguide layers, or the wavelength to vary by the same amount in synchronization. In this way, an embodiment of the present disclosure makes it possible to achieve an optical two-dimensional scanning through a comparatively simple configuration.

The phrase “at least one of the refractive index, the thickness, or the wavelength” herein means at least one selected from the group consisting of the refractive index of an optical waveguide layer, the thickness of an optical waveguide layer, and the wavelength of light that is inputted to an optical waveguide layer. For a change in direction of emission of light, any one of the refractive index, the thickness, and the wavelength may be controlled alone. Alternatively, the direction of emission of light may be changed by controlling any two or all of these three. In each of the following embodiments, the wavelength of light that is inputted to the optical waveguide layer may be controlled instead of or in addition to controlling the refractive index or the thickness.

The foregoing fundamental principles are similarly applicable to uses in which optical signals are received as well as uses in which light is emitted. The direction of light that can be received can be one-dimensionally changed by changing at least one of the refractive index, the thickness, or the wavelength. Furthermore, the direction of light that can be received can be two-dimensionally changed by changing a phase difference of light through a plurality of phase shifters connected separately to each of a plurality of unidirectionally-arrayed waveguide elements.

An optical scan device and an optical receiver device according to an embodiment of the present disclosure may be used, for example, as an antenna in a photodetection system such as a LiDAR (light detection and raging) system. The LiDAR system, which involves the use of short-wavelength electromagnetic waves (visible light, infrared radiation, or ultraviolet radiation), can detect a distance distribution of objects with higher resolution than a radar system that involves the use of radio waves such as millimeter waves. Such a LiDAR system is mounted, for example, on a movable body such as an automobile, a UAV (unmanned aerial vehicle, i.e. a drone), or an AGV (automated guided vehicle), and may be used as one of the crash avoidance technologies. The optical scan device and the optical receiver device are herein sometimes collectively referred to as “optical device”. Further, a device that is used in the optical scan device or the optical receiver device is sometimes referred to as “optical device”, too.

### Example Configuration of Optical Scan Device

The following describes, as an example, a configuration of an optical scan device that performs a two-dimensional scan. Note, however, that an unnecessarily detailed description may be omitted. For example, a detailed description of a matter that is already well known and a repeated description of substantially the same configuration may be omitted. This is intended to facilitate understanding of persons skilled in the art by avoiding making the following description unnecessarily redundant. It should be noted that the inventors provide the accompanying drawings and the following description for persons skilled in the art to fully understand the present disclosure and do not intend to limit the subject matter recited in the claims. In the following description, identical or similar constituent elements are given the same reference numerals.

In the present disclosure, the term “light” means electromagnetic waves including ultraviolet radiation (ranging from approximately 10 nm to approximately 400 nm in wavelength) and infrared radiation (ranging from approximately 700 nm to approximately 1 mm in wavelength) as well as visible light (ranging approximately 400 nm to approximately 700 nm in wavelength). Ultraviolet radiation is herein sometimes referred to as “ultraviolet light”, and infrared radiation is herein sometimes referred to as “infrared light”.

In the present disclosure, an optical “scan” means changing the direction of light. A “one-dimensional scan” means changing the direction of light along a direction that intersects the direction. A “two-dimensional scan” means two-dimensionally changing the direction of light along a plane that intersects the direction.

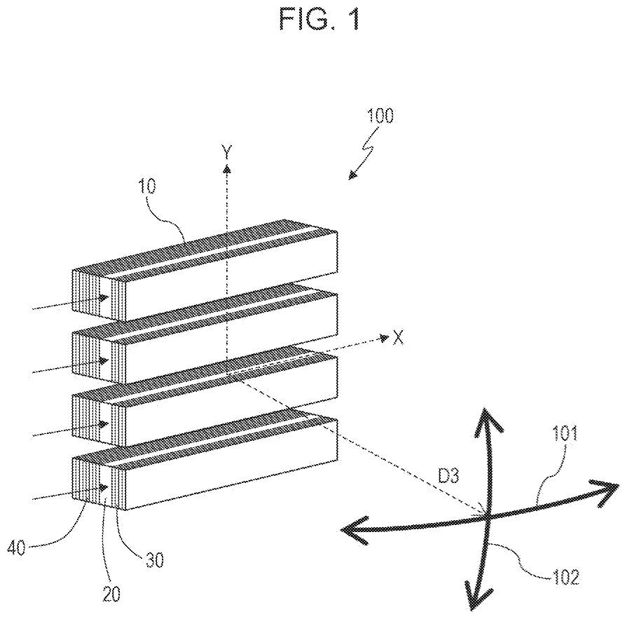

FIG. 1 is a perspective view schematically showing a configuration of an optical scan device 100 according to an exemplary embodiment of the present disclosure. The optical scan device 100 includes a waveguide array including a plurality of waveguide elements 10. Each of the plurality of waveguide elements 10 has a shape extending in a first direction (in FIG. 1, an X direction). The plurality of waveguide elements 10 are regularly arrayed in a second direction (in FIG. 1, a Y direction) that intersects the first direction. The plurality of waveguide elements 10, while propagating light in the first direction, emit the light in a third direction D3 that intersects an imaginary plane parallel to the first and second directions. Although, in the present embodiment, the first direction (X direction) and the second direction (Y direction) are orthogonal to each other, they may not be orthogonal to each other. Although, in the present embodiment, the plurality of waveguide elements 10 are placed at equal spacings in the Y direction, they do not necessarily need to be placed at equal spacings.

It should be noted that the orientation of a structure shown in a drawing of the present disclosure is set in view of understandability of explanation and is in no way intended to restrict the orientation in which an embodiment of the present disclosure is carried out in actuality. Further, the shape and size of the whole or a part of a structure shown in a drawing are not intended to restrict an actual shape and size.

Each of the plurality of waveguide elements 10 has first and second mirrors 30 and 40 (each hereinafter sometimes referred to simply as “mirror”) facing each other and an optical waveguide layer 20 located between the mirror 30 and the mirror 40. Each of the mirrors 30 and 40 has a reflecting surface, situated at the interface with the optical waveguide layer 20, that intersects the third direction D3. The mirror 30, the mirror 40, and the optical waveguide layer 20 have shapes extending in the first direction (X direction).

As will be mentioned later, a plurality of the first mirrors 30 of the plurality of waveguide elements 10 may be a plurality of portions of a mirror of integral construction. Further, a plurality of the second mirrors 40 of the plurality of waveguide elements 10 may be a plurality of portions of a mirror of integral construction. Furthermore, a plurality of the optical waveguide layers 20 of the plurality of waveguide elements 10 may be a plurality of portions of an optical waveguide layer of integral construction. A plurality of waveguides can be formed by at least (1) each first mirror 30 being constructed separately from another first mirror 30, (2) each second mirror 40 being constructed separately from another second mirror 40, or (3) each optical waveguide layer 20 being constructed separately from another optical waveguide layer 20. The phrase “being constructed separately” encompasses not only physically providing space but also separating first mirrors 30, second mirrors 40, or optical waveguide layers 20 from each other by placing a material of a different refractive index between them.

The reflecting surface of the first mirror 30 and the reflecting surface of the second mirror 40 face each other substantially in a parallel fashion. Of the two mirrors 30 and 40, at least the first mirror 30 has the property of transmitting a portion of light propagating through the optical waveguide layer 30. In other words, the first mirror 30 has a higher light transmittance against the light than the second mirror 40. For this reason, a portion of light propagating through the optical waveguide layer 20 is emitted outward from the first mirror 30. Such mirrors 30 and 40 may for example be multilayer mirrors that are formed by multilayer films of dielectrics (sometimes referred to as “multilayer reflective films”).

An optical two-dimensional scan can be achieved by controlling the phases of lights that are inputted to the respective waveguide elements 10 and, furthermore, causing the refractive indices or thicknesses of the optical waveguide layers 20 of these waveguide elements 10 or the wavelengths of lights that are inputted to the optical waveguide layers 20 to simultaneously change in synchronization. In order to achieve such a two-dimensional scan, the inventors conducted an analysis on the principle of operation of a waveguide element 10. As a result of their analysis, the inventors succeeded in achieving an optical two-dimensional scan by driving a plurality of waveguide elements 10 in synchronization.

As shown in FIG. 1, inputting light to each waveguide element 10 causes light to exit the waveguide element 10 through an exit surface of the waveguide element 10. The exit face is located on the side opposite to the reflecting surface of the first mirror 30. The direction D3 of the emitted light depends on the refractive index and thickness of the optical waveguide layer and the wavelength of light. In the present embodiment, at least one of the refractive index of each optical waveguide layer, the thickness of each optical waveguide layer, or the wavelength is controlled in synchronization so that lights that are emitted separately from each waveguide element 10 are oriented in substantially the same direction. This makes it possible to change X-direction components of the wave number vectors of lights that are emitted from the plurality of waveguide elements 10. In other words, this makes it possible to change the direction D3 of the emitted light along a direction 101 shown in FIG. 1.

Furthermore, since the lights that are emitted from the plurality of waveguide elements 10 are oriented in the same direction, the emitted lights interfere with one another. By controlling the phases of the lights that are emitted from the respective waveguide elements 10, a direction in which the lights reinforce one another by interference can be changed. For example, in a case where a plurality of waveguide elements 10 of the same size are placed at equal spacings in the Y direction, lights differing in phase by a constant amount from one another are inputted to the plurality of waveguide elements 10. By changing the phase differences, Y-direction components of the wave number vectors of the emitted lights can be changed. In other words, by varying phase differences among lights that are introduced into the plurality of waveguide elements 10, the direction D3, in which the emitted lights reinforce one another by interference, can be changed along a direction 102 shown in FIG. 1. This makes it possible to achieve an optical two-dimensional scan.

The following describes the principle of operation of the optical scan device 100.

### Principle of Operation of Waveguide Element

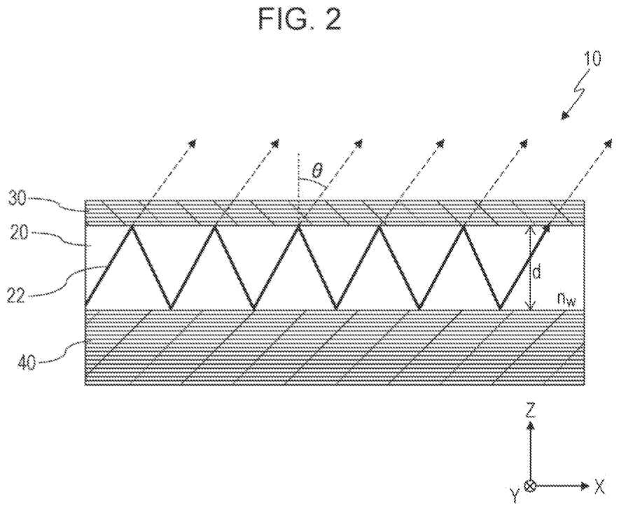

FIG. 2 is a diagram schematically showing an example of a cross-section structure of one waveguide element 10 and an example of propagating light. With a Z direction being a direction perpendicular of the X and Y directions shown in FIG. 1, FIG. 2 schematically shows a cross-section parallel to an X-Z plane of the waveguide element 10. The waveguide element 10 is configured such that the pair of mirrors 30 and 40 are disposed so as to hold the optical waveguide layer 20 therebetween. Light 22 introduced into the optical waveguide layer 20 through one end of the optical waveguide layer 20 in the X direction propagates through the inside of the optical waveguide layer 20 while being repeatedly reflected by the first mirror 30 provided on an upper surface (in FIG. 2, the upper side) of the optical waveguide layer 20 and the second mirror 40 provided on a lower surface (in FIG. 2, the lower side) of the optical waveguide layer 20. The light transmittance of the first mirror 30 is higher than the light transmittance of the second mirror 40. For this reason, a portion of the light can be outputted mainly from the first mirror 30.

In the case of a waveguide such as an ordinary optical fiber, light propagates along the waveguide while repeating total reflection. On the other hand, in the case of a waveguide element 10 according to the present embodiment, light propagates while being repeatedly reflected by the mirrors 30 and 40 disposed above and below, respectively, the optical waveguide layer 20. For this reason, there are no restrictions on angles of propagation of light. The term “angle of propagation of light” here means an angle of incidence on the interface between the mirror 30 or 40 and the optical waveguide layer 20. Light falling on the mirror 30 or 40 at an angle that is closer to the perpendicular can be propagated, too. That is, light falling on the interface at an angle that is smaller than a critical angle of total reflection can be propagated, too. This causes the group speed of light in the direction of propagation of light to be much lower than the speed of light in free space. For this reason, the waveguide element 10 has such a property that conditions for propagation of light vary greatly according to changes in the wavelength of light, the thickness of the optical waveguide layer 20, and the refractive index of the optical waveguide layer 20. Such a waveguide is referred to as “reflective waveguide” or “slow light waveguide”.

The angle of emission θ of light that is emitted into the air from the waveguide element 10 is expressed by Formula (1) as follows:

$$sin θ = \sqrt{{n}_{w}^{2} - {( \frac{m λ}{2 d} )}^{2}} \qquad ( 1 )$$

As can be seen from Formula (1), the direction of emission of light can be changed by changing any of the wavelength λ of light in the air, the refractive index n_{w} of the optical waveguide layer 20, and the thickness d of the optical waveguide layer 20.

For example, in a case where n_{w}=2, d=387 nm, λ=1550 nm, and m=1, the angle of emission is 0 degree. Changing the refractive index from this state to n_{w}=2.2 changes the angle of emission to approximately 66 degrees. Meanwhile, changing the thickness to d=420 nm without changing the refractive index changes the angle of emission to approximately 51 degrees. Changing the wavelength to λ=1500 nm without changing the refractive index or the thickness changes the angle of emission to approximately 30 degrees. In this way, the direction of emission of light can be greatly changed by changing any of the wavelength λ of light, the refractive index n_{w} of the optical waveguide layer 20, and the thickness d of the optical waveguide layer 20.

Accordingly, the optical scan device 100 according to the embodiment of the present disclosure controls the direction of emission of light by controlling at least one of the wavelength λ of light that is inputted to each of the optical waveguide layers 20, the refractive index n_{w} of each of the optical waveguide layers 20, or the thickness d of each of the optical waveguide layers 20. The wavelength λ of light may be kept constant without being changed during operation. In that case, an optical scan can be achieved through a simpler configuration. The wavelength λ is not limited to a particular wavelength. For example, the wavelength λ may be included in a wavelength range of 400 nm to 1100 nm (from visible light to near-infrared light) within which high detection sensitivity is attained by a common photodetector or image sensor that detects light by absorbing light through silicon (Si). In another example, the wavelength λ may be included in a near-infrared wavelength range of 1260 nm to 1625 nm within which an optical fiber or a Si waveguide has a comparatively small transmission loss. It should be noted that these wavelength ranges are merely examples. A wavelength range of light that is used is not limited to a wavelength range of visible light or infrared light but may for example be a wavelength range of ultraviolet light.

In order to change the direction of emitted light, the optical scan device 100 may include a first adjusting element that changes at least one of the refractive index of the optical waveguide layer 20 of each waveguide element 10, the thickness of the optical waveguide layer 20 of each waveguide element 10, or the wavelength.

As stated above, using a waveguide element 10 makes it possible to greatly change the direction of emission of light by changing at least one of the refractive index n_{w} of the optical waveguide layer 20, the thickness d of the optical waveguide layer 20, or the wavelength λ. This makes it possible to change, to a direction along the waveguide element 10, the angle of emission of light that is emitted from the mirror 30. By using at least one waveguide element 10, such a one-dimensional scan can be achieved.

In order to adjust the refractive index of at least a part of the optical waveguide layer 20, the optical waveguide layer 20 may contain a liquid crystal material or an electro-optical material. The optical waveguide layer 20 may be sandwiched between a pair of electrodes. By applying a voltage to the pair of electrodes, the refractive index of the optical waveguide layer 20 can be changed.

In order to adjust the thickness of the optical waveguide layer 20, at least one actuator may be connected, for example, to at least either the first mirror 30 or the second mirror 40. The thickness of the optical waveguide layer 20 can be changed by varying the distance between the first mirror 30 and the second mirror 40 through the at least one actuator. When the optical waveguide layer 20 is formed from liquid, the thickness of the optical waveguide layer 20 may easily change.

### Principle of Operation of Two-Dimensional Scan

In a waveguide array in which a plurality of waveguide elements 10 are unidirectionally arrayed, the interference of lights that are emitted from the respective waveguide elements 10 brings about a change in direction of emission of light. By adjusting the phases of lights that are supplied separately to each waveguide element 10, the direction of emission of light can be changed. The following describes the principles on which it is based.

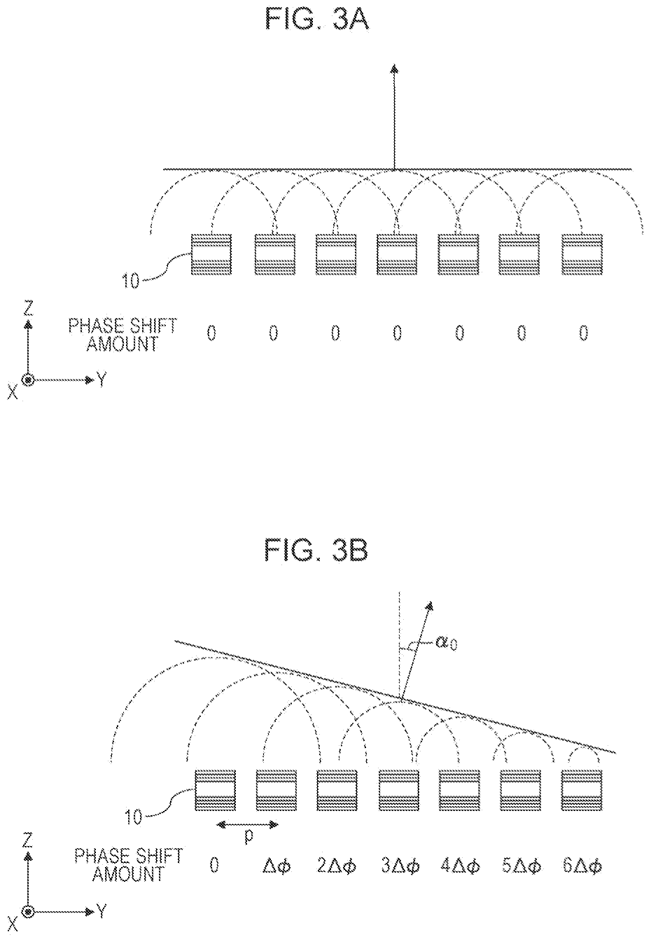

FIG. 3A is a diagram showing a cross-section of a waveguide array that emits light in a direction perpendicular to an exit face of the waveguide array. FIG. 3A also describes the phase shift amounts of lights that propagate separately through each waveguide element 10. Note here that the phase shift amounts are values based on the phase of the light that propagates through the leftmost waveguide element 10. The waveguide array according to the present embodiment includes a plurality of waveguide elements 10 arrayed at equal spacings. In FIG. 3A, the dashed circular arcs indicate the wave fronts of lights that are emitted separately from each waveguide element 10. The straight line indicates a wave front that is formed by the interference of the lights. The arrow indicates the direction of light that is emitted from the waveguide array (i.e. the direction of a wave number vector). In the example shown in FIG. 3A, lights propagating through the optical waveguide layers 20 of each separate waveguide element 10 are identical in phase to one another. In this case, the light is emitted in a direction (Z direction) perpendicular to both an array direction (Y direction) of the waveguide elements 10 and a direction (X direction) in which the optical waveguide layers 20 extend.

FIG. 3B is a diagram showing a cross-section of a waveguide array that emits light in a direction different from a direction perpendicular to an exit face of the waveguide array. In the example shown in FIG. 3B, lights propagating through the optical waveguide layers 20 of the plurality of waveguide elements 10 differ in phase from one another by a constant amount (AO in the array direction. In this case, the light is emitted in a direction different from the Z direction. By varying Δφ, a Y-direction component of the wave number vector of the light can be changed. Assuming that p is the center-to-center distance between two adjacent waveguide elements 10, the angle of emission α₀ of light is expressed by Formula (2) as follows:

$$sin {α}_{0} = \frac{Δϕλ}{2 π p} \qquad ( 2 )$$

In the example shown in FIG. 2, the direction of emission of light is parallel to the X-Z plane. That is, α₀=0°. In each of the examples shown in FIGS. 3A and 3B, the direction of light that is emitted from the optical scan device 100 is parallel to a Y-Z plane. That is, θ=0°. However, in general, the direction of light that is emitted from the optical scan device 100 is not parallel to the X-Z plane or the Y-Z plane. That is, θ≠0° and α₀≠0°.

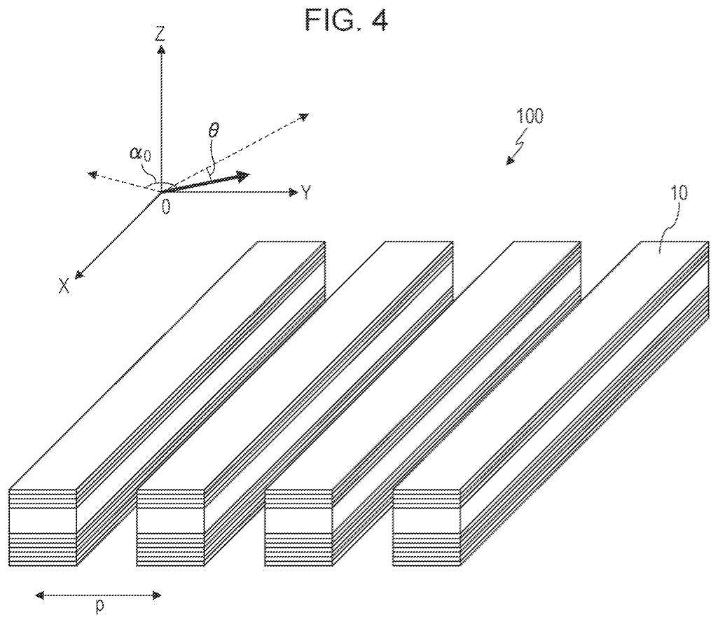

FIG. 4 is a perspective view schematically showing a waveguide array in a three-dimensional space. The bold arrow shown in FIG. 4 represents the direction of light that is emitted from the optical scan device 100. θ is the angle formed by the direction of emission of light and the Y-Z plane. θ satisfies Formula (1). α₀ is the angle formed by the direction of emission of light and the X-Z plane. α₀ satisfies Formula (2).

Phase Control of Light that is Introduced into Waveguide Array

In order to control the phases of lights that are emitted from the respective waveguide elements 10, a phase shifter that changes the phase of light may be provided, for example, at a stage prior to the introduction of light into a waveguide element 10. The optical scan device 100 according to the present embodiment includes a plurality of phase shifters connected separately to each of the plurality of waveguide elements 10 and a second adjusting element that adjusts the phases of lights that propagate separately through each phase shifter. Each phase shifter includes a waveguide joined either directly or via another waveguide to the optical waveguide layer 20 of a corresponding one of the plurality of waveguide elements 10. The second adjusting element varies differences in phase among lights propagating from the plurality of phase shifters to the plurality of waveguide elements 10 and thereby changes the direction (i.e. the third direction D3) of light that is emitted from the plurality of I waveguide elements 10. As is the case with the waveguide array, a plurality of arrayed phase shifters are hereinafter sometimes referred to as “phase shifter array”.

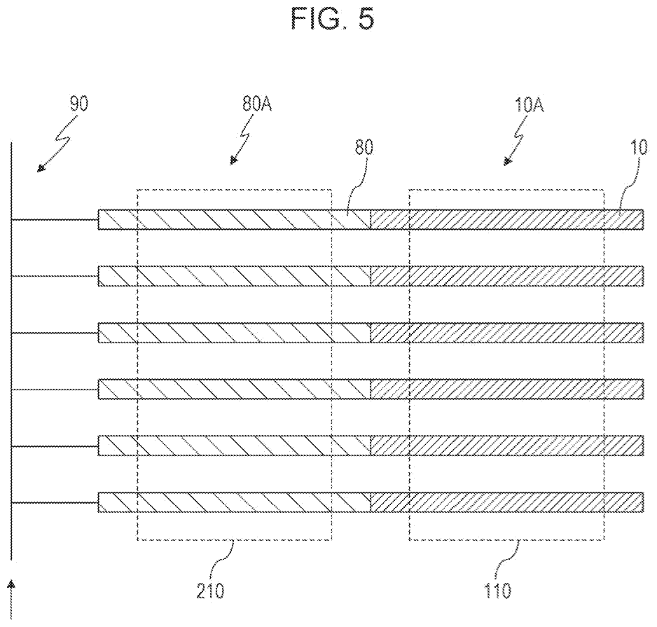

FIG. 5 is a schematic view of a waveguide array 10A and a phase shifter array 80A as seen from a direction (Z direction) normal to a light exit face. In the example shown in FIG. 5, all phase shifters 80 have the same propagation characteristics, and all waveguide elements 10 have the same propagation characteristics. The phase shifter 80 and the waveguide elements 10 may be the same in length or may be different in length. In a case where the phase shifters 80 are equal in length, the respective phase shift amounts can be adjusted, for example, by a driving voltage. Further, by making a structure in which the lengths of the phase shifters 80 vary in equal steps, phase shifts can be given in equal steps by the same driving voltage. Furthermore, this optical scan device 100 further includes an optical divider 90 that divides light into lights and supplies the lights to the plurality of phase shifters 80, a first driving circuit 110 that drives each waveguide element 10, and a second driving circuit 210 that drives each phase shifter 80. The straight arrow shown in FIG. 5 indicates the inputting of light. A two-dimensional scan can be achieved by independently controlling the first driving circuit 110 and the second driving circuit 210, which are separately provided. In this example, the first driving circuit 110 functions as one element of the first adjusting element, and the second driving circuit 210 functions as one element of the second adjusting element.

The first driving circuit 110 changes at least either the refractive index or thickness of the optical waveguide layer 20 of each waveguide element 10 and thereby changes the angle of light that is emitted from the optical waveguide layer 20. The second driving circuit 210 changes the refractive index of the waveguide 20a of each phase shifter 80 and thereby changes the phase of light that propagates through the inside of the waveguide 20a. The optical divider 90 may be constituted by a waveguide through which light propagates by total reflection or may be constituted by a reflective waveguide that is similar to a waveguide element 10.

The lights divided by the optical divider 90 may be introduced into the phase shifters 80 after the phases of the lights have been controlled, respectively. This phase control may involve the use of, for example, a passive phase control structure based on an adjustment of the lengths of waveguides leading to the phase shifters 80. Alternatively, it is possible to use phase shifters that are similar in function to the phase shifters 80 and that can be controlled by electrical signals. The phases may be adjusted by such a method prior to introduction into the phase shifters 80, for example, so that lights of equal phases are supplied to all phase shifters 80. Such an adjustment makes it possible to simplify the control of each phase shifter 80 by the second driving circuit 210.

An optical device that is similar in configuration to the aforementioned optical scan device 100 can also be utilized as an optical receiver device. Details of the principle of operation of the optical device, a method of operation of the optical device, and the like are disclosed in U.S. Patent Application Publication No. 2018/0224709, the disclosure of which is hereby incorporated by reference herein in its entirety.

### Examples of Application

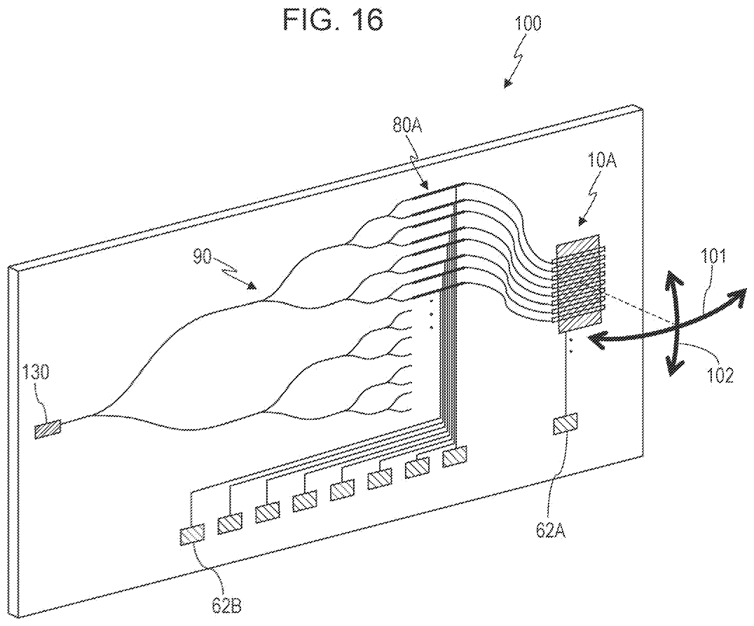

FIG. 16 is a diagram showing an example configuration of an optical scan device 100 in which elements such as an optical divider 90, a waveguide array 10A, a phase shifter array 80A, and a light source 130 are integrated on a circuit board (e.g. a chip). The light source 130 may for example be a light-emitting element such as a semiconductor laser. In this example, the light source 130 emits single-wavelength light whose wavelength in free space is λ. The optical divider 90 divides the light from the light source 130 into lights and introduces the lights into waveguides of the plurality of phase shifters 80. In the example shown in FIG. 16, there are provided an electrode 62A and a plurality of electrodes 62B on the chip. The waveguide array 10A is supplied with a control signal from the electrode 62A. To the plurality of phase shifters 80 in the phase shifter array 80A, control signals are sent from the plurality of electrodes 62B, respectively. The electrode 62A and the plurality of electrodes 62B may be connected to a control circuit (not illustrated) that generates the control signals. The control circuit may be provided on the chip shown in FIG. 16 or may be provided on another chip in the optical scan device 100.

As shown in FIG. 16, an optical scan over a wide range can be achieved through a small-sized device by integrating all components on the chip. For example, all of the components shown in FIG. 16 can be integrated on a chip measuring approximately 2 mm by 1 mm.

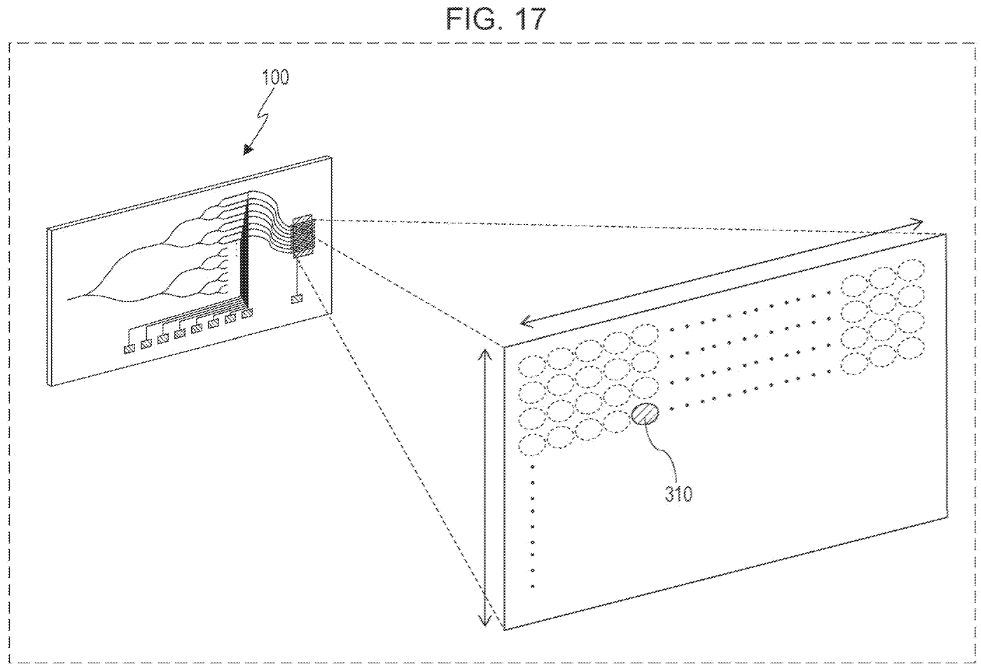

FIG. 17 is a schematic view showing how a two-dimensional scan is being executed by irradiating a distant place with a light beam such as a laser from the optical scan device 100. A two-dimensional can is executed by moving a beam spot 310 in horizontal and vertical directions. For example, a two-dimensional ranging image can be acquired by a combination with a publicly-known TOF (time-of-flight) method. The TOF method is a method for, by observing light reflected from a physical object irradiated with a laser, calculating the time of fight of the light to figure out the distance.

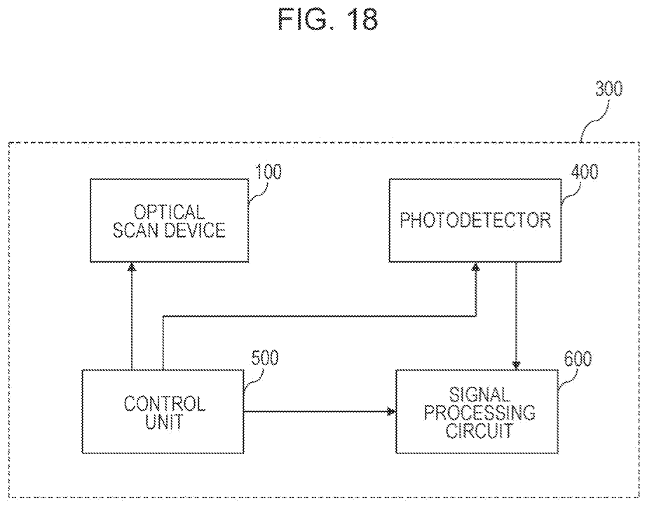

FIG. 18 is a block diagram showing an example configuration of a LiDAR system 300 serving as an example of a photodetection system that is capable of generating such a ranging image. The LiDAR system 300 includes an optical scan device 100, a photodetector 400, a signal processing circuit 600, and a control unit (e.g. a control circuit) 500. The photodetector 400 detects light emitted from the optical scan device 100 and reflected from a physical object. The photodetector 400 may for example be an image sensor that has sensitivity to the wavelength λ of light that is emitted from the optical scan device 100 or a photodetector including a photo-sensitive element such as a photodiode. The photodetector 400 outputs an electrical signal corresponding to the amount of light received. The signal processing circuit 600 calculates the distance to the physical object on the basis of the electrical signal outputted from the photodetector 400 and generates distance distribution data. The distance distribution data is data that represents a two-dimensional distribution of distance (i.e. a ranging image). The control unit 500 is a processor that controls the optical scan device 100, the photodetector 400, and the signal processing circuit 600. The control unit 500 controls the timing of irradiation with a light beam from the optical scan device 100 and the timing of exposure and signal readout of the photodetector 400 and instructs the signal processing circuit 600 to generate a ranging image. Further, the control unit 500 also control a voltage that is applied to an electrode of the optical scan device 100 for an optical scan.

The frame rate at which a ranging image is acquired by a two-dimensional scan can be selected, for example, from among 60 fps, 50 fps, 30 fps, 25 fps, 24 fps, or other frame rates, which are commonly used to acquire moving images. Further, in view of application to an onboard system, a higher frame rate leads to a higher frequency of acquisition of a ranging image, making it possible to accurately detect an obstacle. For example, in the case of a vehicle traveling at 60 km/h, a frame rate of 60 fps makes it possible to acquire an image each time the vehicle moves approximately 28 cm. A frame rate of 120 fps makes it possible to acquire an image each time the vehicle moves approximately 14 cm. A frame rate of 180 fps makes it possible to acquire an image each time the vehicle moves approximately 9.3 cm.

The time required to acquire one ranging image depends on the speed of a beam scan. For example, in order for an image whose number of resolvable spots is 100 by 100 to be acquired at 60 fps, it is necessary to perform a beam scan at 1.67 μs per point. In this case, the control unit 500 controls the emission of a light beam by the optical scan device 100 and the storage and readout of a signal by the photodetector 400 at an operating speed of 600 kHz.

### Example of Application to Optical Receiver Device

Each of the optical scan devices according to the aforementioned embodiments of the present disclosure can also be used as an optical receiver device of similar configuration. The optical receiver device includes a waveguide array 10A which is identical to that of the optical scan device and a first adjusting element that adjusts the direction of light that can be received. Each of the first mirrors 30 of the waveguide array 10A transmits light falling on a side thereof opposite to a first reflecting surface from the third direction. Each of the optical waveguide layers 20 of the waveguide array 10A causes the light transmitted through the first mirror 30 to propagate in the second direction. The direction of light that can be received can be changed by the first adjusting element changing at least one of the refractive index of the optical waveguide layer 20 of each waveguide element 10, the thickness of the optical waveguide layer 20 of each waveguide element 10, or the wavelength of light. Furthermore, in a case where the optical receiver device includes a plurality of phase shifters 80 or 80a and 80b which are identical to those of the optical scan device and a second adjusting element that varies differences in phase among lights that are outputted through the plurality of phase shifters 80 or 80a and 80b from the plurality of waveguide elements 10, the direction of light that can be received can be two-dimensionally changed.

For example, an optical receiver device can be configured such that the light source 130 of the optical scan device 100 shown in FIG. 16 is substituted by a receiving circuit. When light of wavelength λ falls on the waveguide array 10A, the light is sent to the optical divider 90 through the phase shifter array 80A, is finally concentrated on one place, and is sent to the receiving circuit. The intensity of the light concentrated on that one place can be said to express the sensitivity of the optical receiver device. The sensitivity of the optical receiver device can be adjusted by adjusting elements incorporated separately into the waveguide array 10A and the phase shifter array 80A. The optical receiver device is opposite in direction of the wave number vector (in the drawing, the bold arrow) shown, for example, in FIG. 4. Incident light has a light component acting in the direction (in the drawing, the X direction) in which the waveguide elements 10 extend and a light component acting in the array direction (in the drawing, the Y direction) of the waveguide elements 10. The sensitivity to the light component acting in the X direction can be adjusted by the adjusting element incorporated into the waveguide array 10A. Meanwhile, the sensitivity to the light component acting in the array direction of the waveguide elements 10 can be adjusted by the adjusting element incorporated into the phase shifter array 80A. θ and α₀ shown in FIG. 4 are found from the phase difference Δφ of light and the refractive index n_{w} and thickness d of the optical waveguide layer 20 at which the sensitivity of the optical receiver device reaches its maximum. This makes it possible to identify the direction of incidence of light.

Orientational Control of Liquid Crystal Material within Optical Waveguide Layer

The direction of light that is emitted from the optical device 100 can be changed by applying an electric field from an outside source to the optical waveguide layer 20, which contains the liquid crystal material. In general, for driving of liquid crystals, an alignment process is performed on at least a part of the inside of the optical waveguide layer 20. As a conventional alignment process, for example, a resin layer such as polyimide is provided in at least the part of the inside of the optical waveguide layer 20. The resin layer is called “alignment film”. Making desired scratches on the alignment film by a method such as rubbing causes the liquid crystal material to be oriented in an orientation direction along the scratches. Thus, initial orientation of the liquid crystal material in the absence of the application of an electric field is achieved.

On the other hand, in the present disclosure, as will be mentioned later, an area through which light is guided is located between the mirror 30 and the mirror 40 and between two dielectric members adjacent to each other in the Y direction. The spacing between the two adjacent dielectric members is narrow, and may be less than or equal to 5 μm. In this case, it is not easy to uniformly form an alignment film in the area surrounded by the two adjacent dielectric members or to perform rubbing on the alignment film thus formed.

Based on the foregoing study, the inventors conceived optical devices described in the following items.

An optical device according to a first item includes: a first mirror having translucency and including a first reflecting surface extending along a first direction and a second direction intersecting the first direction; a second mirror including a second reflecting surface facing the first reflecting surface; an optical waveguide layer located between the first mirror and the second mirror, the optical waveguide layer including a plurality of non-waveguide areas laid side-by-side along the second direction and one or more optical waveguide areas located between the plurality of non-waveguide areas, the optical waveguide areas containing a liquid crystal material and propagating light along the first direction; and two electrode layers facing each other across the optical waveguide layer, at least one of the two electrode layers including a plurality of electrodes laid side-by-side along the second direction. The plurality of electrodes include an electrode overlapping at least a part of the plurality of non-waveguide areas when seen from an angle parallel with a direction perpendicular to the first reflecting surface or the second reflecting surface.

In this optical device, the refractive index of the liquid crystal material contained in the optical waveguide areas can be changed by an electric field that is formed by voltages applied to an electrode included in one of the two electrode layers and/or an electrode included in the other. This brings about a change in direction of light that is emitted from the first mirror.

An optical device according to a second item is directed to the optical device according to the first item, further including a control circuit connected to each of the plurality of electrodes included in the two electrode layers. The control circuit executes, during operation, at least either a first operation of providing a potential difference between at least a part of the plurality of electrodes and at least another part of the plurality of electrodes or a second operation of providing a potential difference between an electrode included in one of the two electrode layers and an electrode included in the other of the two electrode layers.

In this optical device, the refractive index of the liquid crystal material contained in the optical waveguide areas can be continuously changed by the aforementioned operation of the control circuit. This entails a continuous change in angle of emission of light that is emitted from the first mirror, too.

An optical device according to a third item is directed to the optical device according to the first or second item, wherein one of the two electrode layers is located between the optical waveguide layer and the first reflecting surface, inside the first mirror, or on a surface of the first mirror opposite to the first reflecting surface, and the other of the two electrode layers is located between the optical waveguide layer and the second reflecting surface, inside the second mirror, or on a surface of the second mirror opposite to the second reflecting surface.

This optical device can bring about the same effects as the optical device according to the first or second item by having the two electrode layers provided in the aforementioned locations.

An optical device according to a fourth item is directed to the optical device according to any of the first to third items, wherein the one or more optical waveguide areas include an optical waveguide area whose width in the second direction is less than or equal to 5 μm.

This optical device can bring about the same effects as the optical device according to the first or third item even when the width of an optical waveguide area in the second direction is less than or equal to 5 μm.

An optical device according to a fifth item is directed to the optical device according to the first item, further including a control circuit connected to each electrode included in the two electrode layers. The plurality of electrodes overlap at least parts of the plurality of non-waveguide areas, respectively, when seen from an angle parallel with a direction perpendicular to the first reflecting surface or the second reflecting surface. The control circuit executes, during operation, at least either a first operation of providing a potential difference between any adjacent two of the plurality of electrodes and a second operation of providing a potential difference between an electrode included in one of the two electrode layers and an electrode included in the other of the two electrode layers.

In this optical device, the refractive index of the liquid crystal material contained in the optical waveguide areas can be continuously changed by the aforementioned operation of the control circuit on the plurality of electrodes. This entails a continuous change in angle of emission of light that is emitted from the first mirror, too.

An optical device according to a sixth item is directed to the optical device according to any of the first to fourth items, wherein the plurality of electrodes include a plurality of first electrodes overlapping at least parts of the plurality of non-waveguide areas, respectively, when seen from an angle parallel with a direction perpendicular to the first reflecting surface or the second reflecting surface and one or more second electrodes overlapping at least parts of the one or more optical waveguide areas, respectively, when seen from an angle parallel with the direction perpendicular to the first reflecting surface or the second reflecting surface.

This optical device can bring about the same effects as the optical device according to any of the first to fourth items by having the plurality of electrodes thus provided.

An optical device according to a seventh item is directed to the optical device according to the first item, further including a control circuit connected to each electrode included in the two electrode layers. The plurality of electrodes include a plurality of first electrodes overlapping at least parts of the plurality of non-waveguide areas, respectively, when seen from an angle parallel with a direction perpendicular to the first reflecting surface or the second reflecting surface and one or more second electrodes overlapping at least parts of the one or more optical waveguide areas, respectively, when seen from an angle parallel with the direction perpendicular to the first reflecting surface or the second reflecting surface. The control circuit executes, during operation, at least either a first operation of providing a potential difference between any adjacent two of the plurality of first electrodes and a second operation of providing a potential difference between an electrode included in one of the two electrode layers and an electrode included in the other of the two electrode layers.

In this optical device, the refractive index of the liquid crystal material contained in the optical waveguide areas can be continuously changed by the aforementioned operation of the control circuit on the plurality of electrodes. This entails a continuous change in angle of emission of light that is emitted from the first mirror, too.

An optical device according to an eighth item is directed to the optical device according to any of the first to seventh items, wherein one of the two electrode layers includes the plurality of electrodes, and the other of the two electrode layers includes a single electrode.

This optical device can bring about the same effects as the optical device according to any of the first to seventh items by having the two electrode layers thus provided.

An optical device according to a ninth item is directed to the optical device according to any of the first to seventh items, wherein both of the two electrode layers include the plurality of electrodes.

This optical device can bring about the same effects as the optical device according to any of the first to seventh items by having the two electrode layers thus provided.

The following describes optical devices 100 according to Embodiments 1 to 6.

### Embodiment 1

The following describes an example in which an optical scan is executed by driving a liquid crystal material contained in an area through which light is guided.

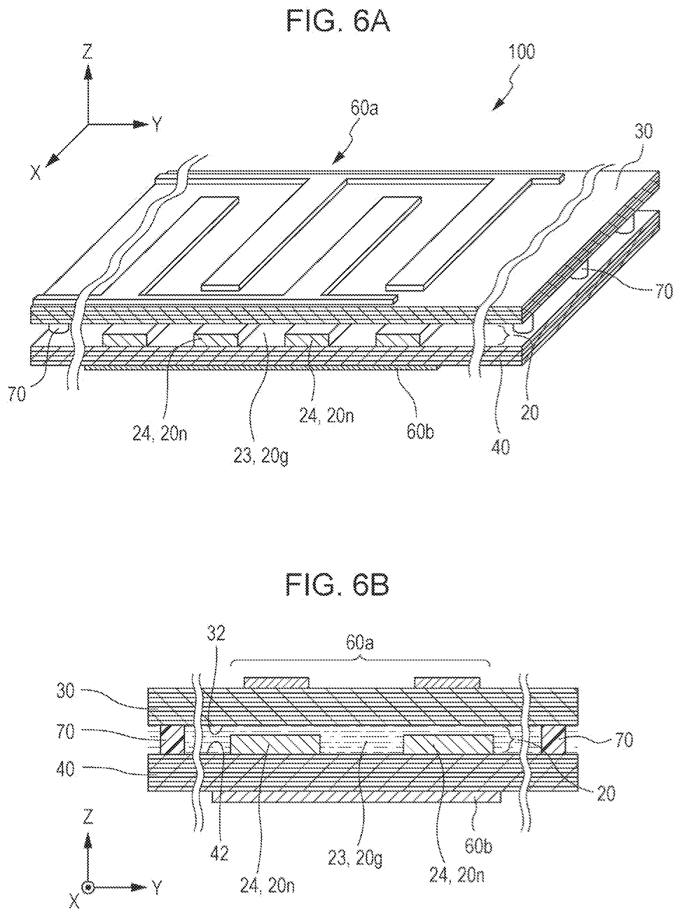

FIG. 6A is a perspective view of an optical device 100 according to an exemplary embodiment of the present disclosure. FIG. 6B is a cross-sectional view of the optical device 100 shown in FIG. 6A as taken along the Y-Z plane. For simplicity, FIGS. 6A and 6B show part of the optical device 100. The X, Y, and Z directions, which are orthogonal to one another, are shown for convenience sake, and are not intended to limit the actual orientation of the optical device 100.

The optical device 100 according to the present embodiment includes mirrors 30 and 40, an optical waveguide layer 20, and electrode layers 60a and 60b. The optical device 100 may further include a control circuit (not illustrated).

The mirror 30 includes a first reflecting surface 32 extending along the X direction and the Y direction. The mirror 30 has translucency. The mirror 40 has a second reflecting surface 42 facing the first reflecting surface 32. The mirror 30 and the mirror 40 are supported by supporting members 70 so as to be substantially parallel to each other. The supporting members 70 are formed, for example, from a dielectric material such as SiO₂ or resin. The supporting members 70 may each have a columnar or wall shape. The supporting members 70 are disposed over a wide range in areas other than the optical waveguide layer 20 between the mirror 30 and the mirror 40. The optical device 100 may be fabricated by bonding the mirror 30 and the mirror 40 together.

The optical waveguide layer 20 is located between the mirror 30 and the mirror 40. In the optical waveguide layer 20, a plurality of dielectric members 24 are laid side-by-side along the Y direction. Areas in the optical waveguide layer 20 overlapping the plurality of dielectric members 24 when seen from an angle parallel with the Z direction is referred to as “plurality of non-waveguide areas 20n”. One or more areas in the optical waveguide layer 20 located between the plurality of non-waveguide areas 20n laid side-by-side along the Y direction is referred to as “one or more optical waveguide areas 20g”. In other words, the optical waveguide layer 20 includes the plurality of non-waveguide areas 20n and the one or more optical waveguide areas 20g. The average refractive index of the one or more optical waveguide areas 20g is higher than the average refractive index of the plurality of non-waveguide areas 20n. For this reason, the one or more optical waveguide areas 20g can guide light along the X direction. Each of the one or more optical waveguide areas 20g contains a liquid crystal material 23. The plurality of non-waveguide areas 20n includes the plurality of dielectric members 24, respectively. In the example shown in FIGS. 6A and 6B, there is a gap between a dielectric member 24 and the mirror 30. There may be a gap, provided light propagating through one of any two adjacent optical waveguide areas 20g does not leak to the other. The presence of such a gap makes it possible to easily bond the mirror 30 and the mirror 40 together even if the plurality of dielectric members 24 are not equal in height in the Z direction. Parts of the optical waveguide layer 20 shown in FIGS. 6A and 6B other than the plurality of dielectric members 24 are filled with the liquid crystal material 23.

The electrode layer 60a and the electrode layer 60b face each other across the optical waveguide layer 20. In the example shown in FIGS. 6A and 6B, the electrode layer 60a includes a plurality of electrodes laid side-by-side along the Y direction, and the electrode layer 60b includes a single electrode. As shown in FIG. 6A, the plurality of electrodes of the electrode layer 60a may include a first subset of electrodes projecting from a first one to a second one of two electrodes extending in the Y direction and a second subset of electrodes projecting from the second electrode to the first electrode and being located between the first subset of electrodes. In the example shown in FIGS. 6A and 6B, the electrode layer 60a is located on a surface of the mirror 30 opposite to the first reflecting surface 32, and the electrode layer 60b is located on a surface of the mirror 40 opposite to the second reflecting surface 42. The electrode layer 60a may be located between the optical waveguide layer 20 and the first reflecting surface 32 of the mirror 30 or inside the mirror 30. Similarly, the electrode layer 60b may be located between the optical waveguide layer 20 and the second reflecting surface 42 of the mirror 40 or inside the mirror 40. In the example shown in FIGS. 6A and 6B, the plurality of electrodes of the electrode layer 60a overlap at least parts of the plurality of non-waveguide areas 20n, respectively, when seen from an angle parallel with the Z direction. More specifically, the plurality of electrodes of the electrode layer 60a are included in the plurality of non-waveguide areas 20n, respectively, when seen from an angle parallel with the Z direction. The plurality of electrodes of the electrode layer 60a may be formed from an electrode material having translucency against the wavelength of light propagating through the inside of the one or more optical waveguide areas 20g. The electrode material is a transparent electrode such as ITO. However, any electrode material will do, provided it does not prevent passage of light. The electrode material may contain a conductive metal such as Al, provided the plurality of electrodes of the electrode layer 60a do not overlap the one or more optical waveguide areas 20g when seen from an angle parallel with the Z direction. The single electrode of the electrode layer 60b may contain a transparent electrode and/or a conductive metal.

The control circuit (not illustrated) is connected to each of the plurality of electrodes included in the electrode layers 60a and 60b. In the example shown in FIGS. 6A and 6B, the control circuit (not illustrated) is connected to each of the plurality of electrodes of the electrode layer 60a via one of the two parallel electrodes extending in the Y direction. The control circuit can independently apply any voltages to each of the plurality of electrodes of the electrode layer 60a and the single electrode of the electrode 60b. In the example shown in FIGS. 6A and 6B, voltages of two different values are alternately applied or voltages of the same value are applied to the plurality of electrodes of the electrode layer 60a. By causing a desired electric field to be generated between the mirror 30 and the mirror 40 from the plurality of electrodes of the electrode layer 60a and the single electrode of the electrode layer 60b, the liquid crystal material 23, which fills the space between the mirror 30 and the mirror 40, is driven. This brings about a change in refractive index of the liquid crystal material 23.

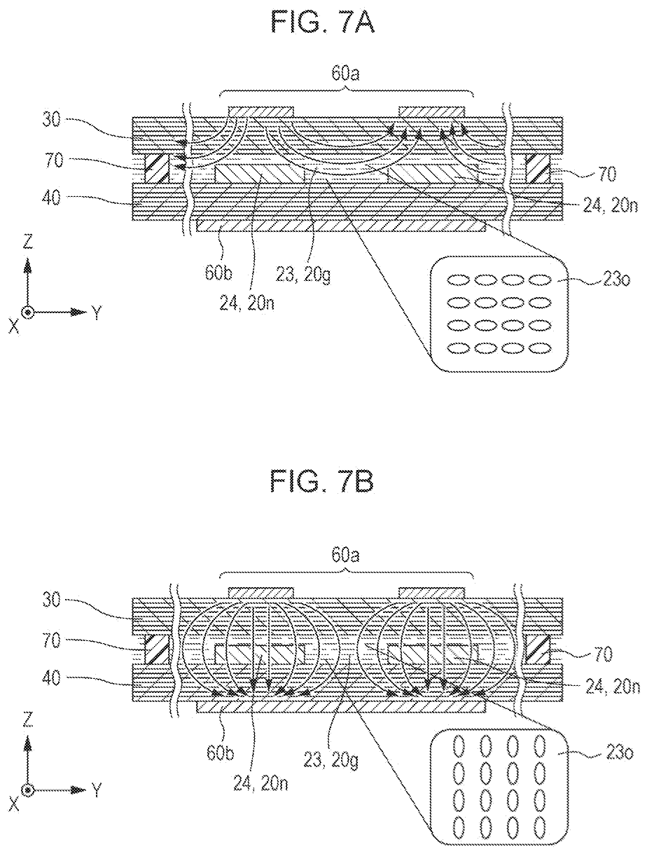

Next, orientational control of the liquid crystal material 23 according to the present embodiment is described with reference to FIGS. 7A and 7B.

FIG. 7A is a diagram schematically showing a first state in which the liquid crystal material 23 is oriented in the Y direction in the example shown in FIG. 6B. FIG. 7B is a diagram schematically showing a second state in which the liquid crystal material 23 is oriented in the Z direction in the example shown in FIG. 6B. In FIGS. 7A and 7B, the sign “23o” schematically represents an orientational state of the liquid crystal material 23. The orientation direction of the liquid crystal material 23 sandwiched between the mirror 30 and the mirror 40 is controlled by an electric field that is formed by the voltages applied to the plurality of electrodes of the electrode layer 60a and the single electrode of the electrode layer 60b.

In the example shown in FIG. 7A, a potential difference is provided between any adjacent two of the plurality of electrodes of the electrode layer 60a, and the single electrode of the electrode layer 60b is electrically open. In this state, as shown in FIG. 7A, the potential difference produced between the two adjacent electrodes causes lines of electric force substantially parallel with the Y direction to appear in the one or more optical waveguide areas 20g. This electric field causes the liquid crystal material 23 contained in the one or more optical waveguide areas 20g to be oriented in the Y direction.

In the example shown in FIG. 7B, the plurality of electrodes of the electrode layer 60a are at substantially the same potential, and a potential difference is provided between the plurality of electrodes of the electrode layer 60a and the single electrode of the electrode layer 60a. In this state, as shown in FIG. 7B, lines of electric force substantially parallel with the Z direction appear from the mirror 30 toward the mirror 40. This causes the liquid crystal material 23 contained in the one or more optical waveguide areas 20g to be oriented in the Z direction. Although, in the example shown in FIG. 7B, the lines of electric force appear from the mirror 30 toward the mirror 40, the opposite may be true.

By thus applying voltages to the plurality of electrodes of the electrode layer 60a and the single electrode of the electrode layer 60b, the first state shown in FIG. 7A and the second state shown in FIG. 7B can be arbitrarily created. The first state and the second state differ from each other in refractive index of the liquid crystal material 23 contained in the one or more optical waveguide areas 20g. In the process of a transition from the first state to the second state and a transition from the second state to the first state, the refractive index of the liquid crystal material 23 continuously changes. This entails a change in angle of emission of light that is emitted from the mirror 30. As a result, an optical scan can be achieved.

In order to achieve the transition from the first state to the second state and the transition from the second state to the first state, the control circuit (not illustrated) executes, during operation, at least either a first operation of providing a potential difference between at least a part of the plurality of electrodes of the electrode layer 60a and at least another part of the plurality of electrodes of the electrode layer 60a or a second operation of providing a potential difference between an electrode included in one of the electrode layers 60a and 60b and an electrode included in the other.

The width of each electrode of the electrode layer 60a in the Y direction may be narrower than the width of one non-waveguide area 20n in the Y direction. This causes the lines of electric force formed in the one or more optical waveguide areas 20g to be more parallel with the Y direction in the first state shown in FIG. 7A.

Contrary to the examples shown in FIGS. 7A and 7B, the electrode layer 60a on the mirror 30 may include a single electrode, and the electrode layer 60b on the mirror 40 may include a plurality of electrodes. This configuration too can bring about effects which are similar to those brought about by the examples shown in FIGS. 7A and 7B.

It should be noted that not all of the plurality of electrodes of the electrode layer 60a need to overlap at least parts of the plurality of non-waveguide areas 20n, respectively, when seen from an angle parallel with the Z direction. A first part of the plurality of electrodes of the electrode layers 60a may include electrodes overlapping at least parts of the plurality of non-waveguide areas 20n when seen from an angle parallel with the Z direction, and a second part of the plurality of electrodes of the electrode layers 60a may not include such electrodes, provided effects which are similar to those brought about by the examples shown in FIGS. 7A and 7B can be brought about.

### Embodiment 2

The following description omits to describe configurations which are the same as those of the examples shown in Embodiment 1.

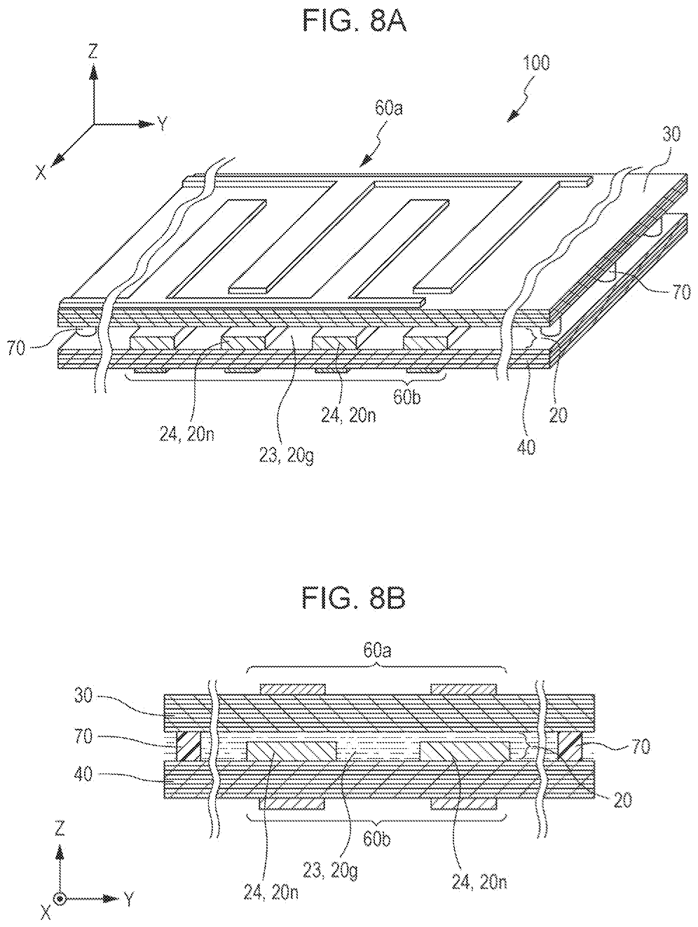

FIG. 8A is a perspective view of an optical device 100 according to an exemplary embodiment of the present disclosure. FIG. 8B is a cross-sectional view of the optical device 100 shown in FIG. 8A as taken along the Y-Z plane. For simplicity, FIGS. 8A and 8B show part of the optical device 100.

In the example shown in FIGS. 8A and 8B, unlike in the example shown in Embodiment 1, the electrode layer 60b includes a plurality of electrodes as is the case with the electrode layer 60a. Any voltages can be independently applied to each of the plurality of electrodes of the electrode layer 60a and each of the plurality of electrodes of the electrode 60b.

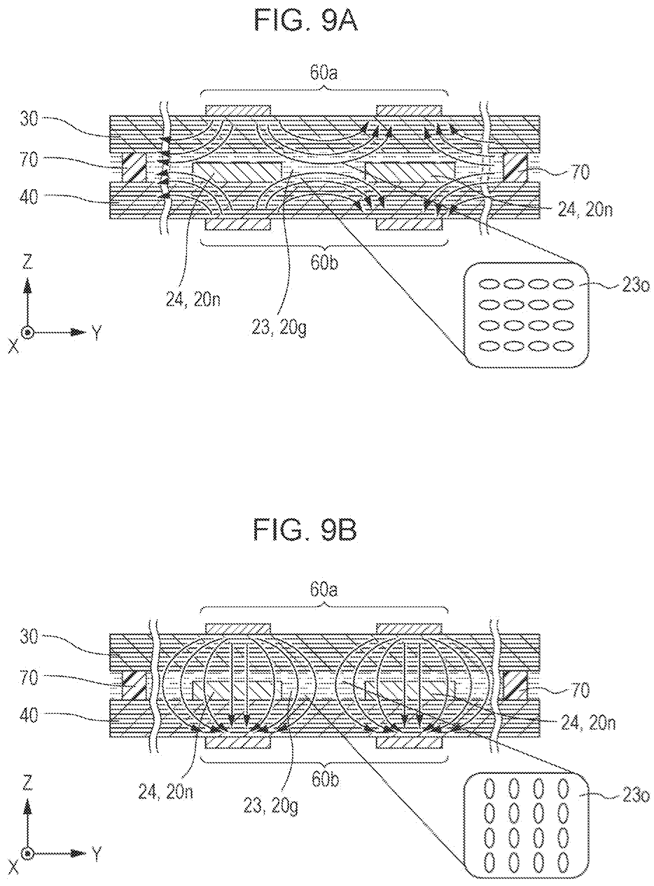

Next, orientational control of a liquid crystal material 23 according to the present embodiment is described with reference to FIGS. 9A and 9B.

FIG. 9A is a diagram schematically showing a first state in which the liquid crystal material 23 is oriented in the Y direction in the example shown in FIG. 8B. FIG. 9B is a diagram schematically showing a second state in which the liquid crystal material 23 is oriented in the Z direction in the example shown in FIG. 8B. The orientation direction of the liquid crystal material 23 sandwiched between the mirror 30 and the mirror 40 is controlled by an electric field that is formed by voltages applied to the plurality of electrodes of the electrode layer 60a and the plurality of electrodes of the electrode layer 60b.

In the example shown in FIG. 9A, a potential difference is provided between any adjacent two of the plurality of electrodes of the electrode layer 60a, and a potential difference is provided between any adjacent two of the plurality of electrodes of the electrode layer 60b. Two electrodes facing each other across the optical waveguide layer 20 may be at the same potential. In this state, as shown in FIG. 9A, the potential difference produced between the two adjacent electrodes cause lines of electric force substantially parallel with the Y direction to appear in the one or more optical waveguide areas 20g. This causes the liquid crystal material 23 contained in the one or more optical waveguide areas 20g to be oriented in the Y direction.

In the example shown in FIG. 9B, the plurality of electrodes of the electrode layer 60a are at substantially the same potential, and the plurality of electrodes of the electrode layer 60b are at substantially the same potential, with a potential difference provided between the plurality of electrodes of the electrode layer 60a and plurality of electrodes of the electrode layer 60b. In this state, as shown in FIG. 9B, lines of electric force substantially parallel with the Z direction appear from the mirror 30 toward the mirror 40. This causes the liquid crystal material 23 contained in the one or more optical waveguide areas 20g to be oriented in the Z direction. Although, in the example shown in FIG. 9B, the lines of electric force appear from the mirror 30 toward the mirror 40, the opposite may be true.

By thus applying voltages to the plurality of electrodes of the electrode layer 60a and the plurality of electrodes of the electrode layer 60b, the first state shown in FIG. 9A and the second state shown in FIG. 9B can be arbitrarily created. The first state and the second state differ from each other in refractive index of the liquid crystal material 23 contained in the one or more optical waveguide areas 20g. In the process of a transition from the first state to the second state and a transition from the second state to the first state, the refractive index of the liquid crystal material 23 continuously changes. This entails a change in angle of emission of light that is emitted from the mirror 30. As a result, an optical scan can be achieved.

The width of each electrode of the electrode layer 60a in the Y direction may be narrower than the width of each non-waveguide area 20n in the Y direction. This causes the lines of electric force formed in the one or more optical waveguide areas 20g to be more parallel with the Y direction in the first state shown in FIG. 9A.

It should be noted that not all of the plurality of electrodes of the electrode layer 60b need to overlap at least parts of the plurality of non-waveguide areas 20n, respectively, when seen from an angle parallel with the Z direction. A first part of the plurality of electrodes of the electrode layers 60b may include electrodes overlapping at least parts of the plurality of non-waveguide areas 20n when seen from an angle parallel with the Z direction, and a second part of the plurality of electrodes of the electrode layers 60b may not include such electrodes, provided effects which are similar to those brought about by the examples shown in FIGS. 9A and 9B can be brought about.

### Embodiment 3

The following description omits to describe configurations which are the same as those of the examples shown in Embodiment 1.

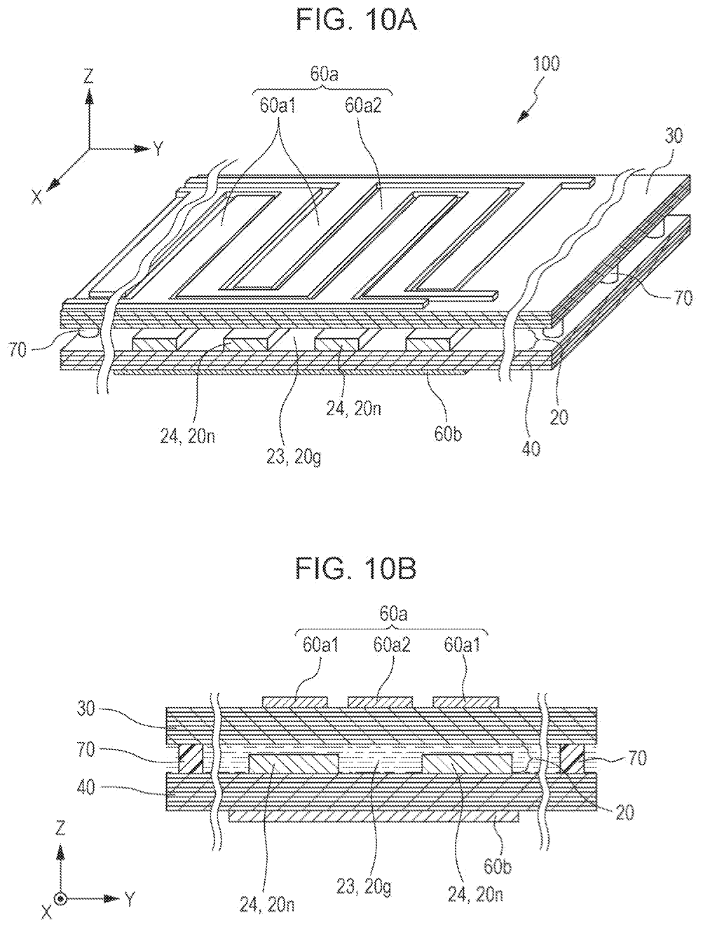

FIG. 10A is a perspective view of an optical device 100 according to an exemplary embodiment of the present disclosure. FIG. 10B is a cross-sectional view of the optical device 100 shown in FIG. 10A as taken along the Y-Z plane. For simplicity, FIGS. 10A and 10B show part of the optical device 100.

In the example shown in FIGS. 10A and 10B, unlike in the example shown in Embodiment 1, the plurality of electrodes of the electrode layer 60a include a plurality of first electrodes 60a1 and one or more second electrodes 60a2. The plurality of first electrodes 60a1 are equivalent to the plurality of electrodes of the electrode layer 60a shown in FIGS. 6A and 6B. The one or more second electrodes 60a2 overlap at least parts of the one or more optical waveguide areas 20g, respectively, when seen from an angle parallel with the Z direction. More specifically, the one or more second electrodes 60a2 are included in the one or more optical waveguide areas 20g, respectively, when seen from an angle parallel with the Z direction.

As shown in FIG. 10A, the one or more second electrodes 60a2 may be a part of one continuous electrode disposed in gaps between the plurality of first electrodes 60a1. Any voltages can be independently applied to each of the plurality of electrodes of the electrode layer 60a and the single electrode of the electrode 60b. In the example shown in FIGS. 10A and 10B, voltages of two different values are alternately applied or voltages of the same value are applied to the plurality of first electrodes 60a1 of the electrode layer 60a. Voltages of the same value are applied to the one or more second electrodes 60a2 of the electrode layer 60a.

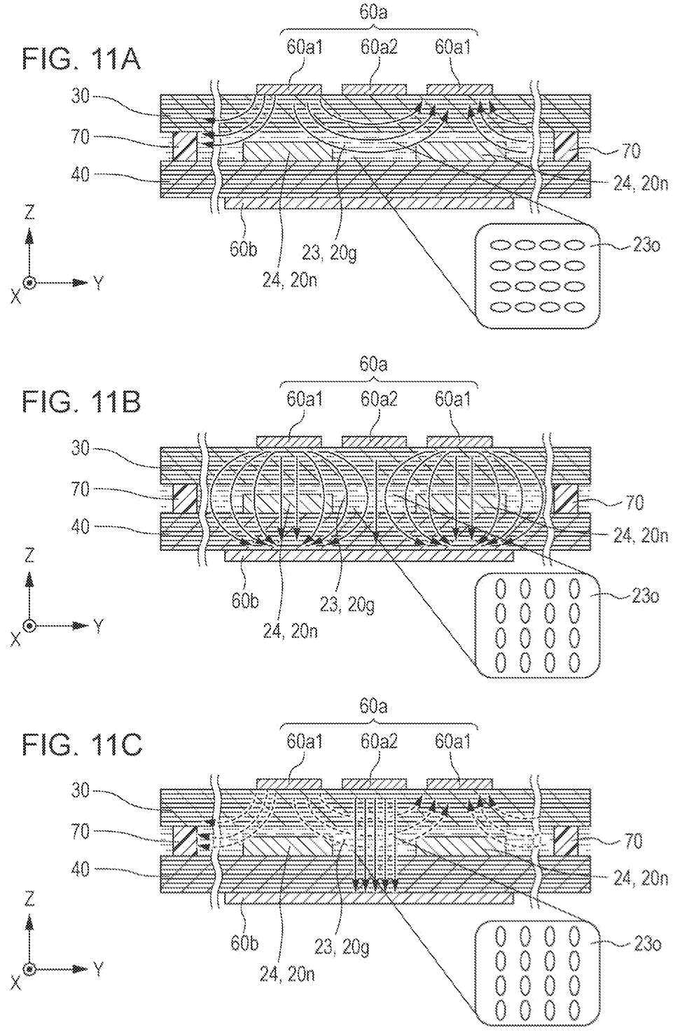

Next, orientational control of a liquid crystal material 23 according to the present embodiment is described with reference to FIGS. 11A and 11B.

FIG. 11A is a diagram schematically showing a first state in which the liquid crystal material 23 is oriented in the Y direction in the example shown in FIG. 10B. FIGS. 11B and 11C are each a diagram schematically showing a second state in which the liquid crystal material 23 is oriented in the Z direction in the example shown in FIG. 10B. The orientation direction of the liquid crystal material 23 sandwiched between the mirror 30 and the mirror 40 is controlled by an electric field that is formed by voltages applied to the plurality of first electrodes 60a1 and the one or more second electrodes 60a2 of the electrode layer 60a and the single electrode of the electrode layer 60b.

In the example shown in FIG. 11A, a potential difference is provided between any adjacent two of the plurality of first electrodes 60a1 of the electrode layer 60a, and the one or more second electrodes 60a2 of the electrode layer 60a and the single electrode of the electrode layer 60b are electrically open. In this state, as shown in FIG. 11A, the potential difference produced between the two adjacent electrodes causes lines of electric force substantially parallel with the Y direction to appear in the one or more optical waveguide areas 20g. This causes the liquid crystal material 23 contained in the one or more optical waveguide areas 20g to be oriented in the Y direction.

In the example shown in FIG. 11B, the plurality of first electrodes 60a1 and the one or more second electrodes 60a2 of the electrode layer 60a are at substantially the same potential, and a potential difference is provided between the plurality of first electrodes 60a1 and the one or more second electrodes 60a2 of the electrode layer 60a and the single electrode of the electrode layer 60b. In this state, as shown in FIG. 11B, lines of electric force substantially parallel with the Z direction appear from the mirror 30 toward the mirror 40. This causes the liquid crystal material 23 contained in the one or more optical waveguide areas 20g to be oriented in the Z direction. Although, in the example shown in FIG. 11B, the lines of electric force appear from the mirror 30 toward the mirror 40, the opposite may be true.

In the example shown in FIG. 11C, a first potential difference is provided between any adjacent two of the plurality of first electrodes 60a1 of the electrode layer 60a, and a second potential difference is provided between the one or more second electrodes 60a2 of the electrode layer 60a and the single electrode of the electrode layer 60b. The first potential difference may be smaller than the potential difference in the example shown in FIG. 11A, and may be smaller than the second potential difference. In this state, as shown in FIG. 11C, lines of electric force substantially parallel with the Z direction appear from the mirror 30 toward the mirror 40. This causes the liquid crystal material 23 contained in the one or more optical waveguide areas 20g to be oriented in the Z direction. Although, in the example shown in FIG. 11C, the lines of electric force appear from the mirror 30 toward the mirror 40, the opposite may be true. The state shown in FIG. 11C too can be said to be the second state in which the liquid crystal material 23 contained in the one or more optical waveguide areas 20g is oriented in the Z direction by an electric field that is generated between the one or more second electrodes 60a2 of the electrode layer 60a and the single electrode of the electrode layer 60b.

By thus applying voltages to the plurality of first electrodes 60a1 and the one or more second electrodes 60a2 of the electrode layer 60a and the single electrode of the electrode layer 60b, the first state shown in FIG. 11A and the second state shown in FIGS. 11B and 11C can be arbitrarily created. The first state and the second state differ from each other in refractive index of the liquid crystal material 23 contained in the one or more optical waveguide areas 20g. In the process of a transition from the first state to the second state and a transition from the second state to the first state, the refractive index of the liquid crystal material 23 continuously changes. This entails a change in angle of emission of light that is emitted from the mirror 30. As a result, an optical scan can be achieved.

The width of each first electrode 60a1 of the electrode layer 60a in the Y direction may be narrower than the width of each non-waveguide area 20n in the Y direction. This causes the lines of electric force formed in the one or more optical waveguide areas 20g to be more parallel with the Y direction in the first state shown in FIG. 11A.

It should be noted that not all of the plurality of first electrodes 60a1 of the electrode layer 60a need to overlap at least parts of the plurality of non-waveguide areas 20n, respectively, when seen from an angle parallel with the Z direction. A first part of the plurality of first electrodes 60a1 of the electrode layers 60a may include electrodes overlapping at least parts of the plurality of non-waveguide areas 20n when seen from an angle parallel with the Z direction, and a second part of the plurality of first electrodes 60a1 of the electrode layers 60a may not include such electrodes, provided effects which are similar to those brought about by the examples shown in FIGS. 11A and 11B can be brought about.

It should be noted that not all of the one or more second electrodes 60a2 of the electrode layer 60a need to overlap at least parts of the plurality of optical waveguide areas 20g, respectively, when seen from an angle parallel with the Z direction. A first part of the one or more second electrodes 60a2 of the electrode layers 60a may include electrodes overlapping at least parts of the plurality of optical waveguide areas 20g when seen from an angle parallel with the Z direction, and a second part of the one or more second electrodes 60a2 of the electrode layers 60a may not include such electrodes, provided effects which are similar to those brought about by the examples shown in FIGS. 11A and 11B can be brought about.

### Embodiment 4

The following description omits to describe configurations which are the same as those of the examples shown in Embodiment 3.

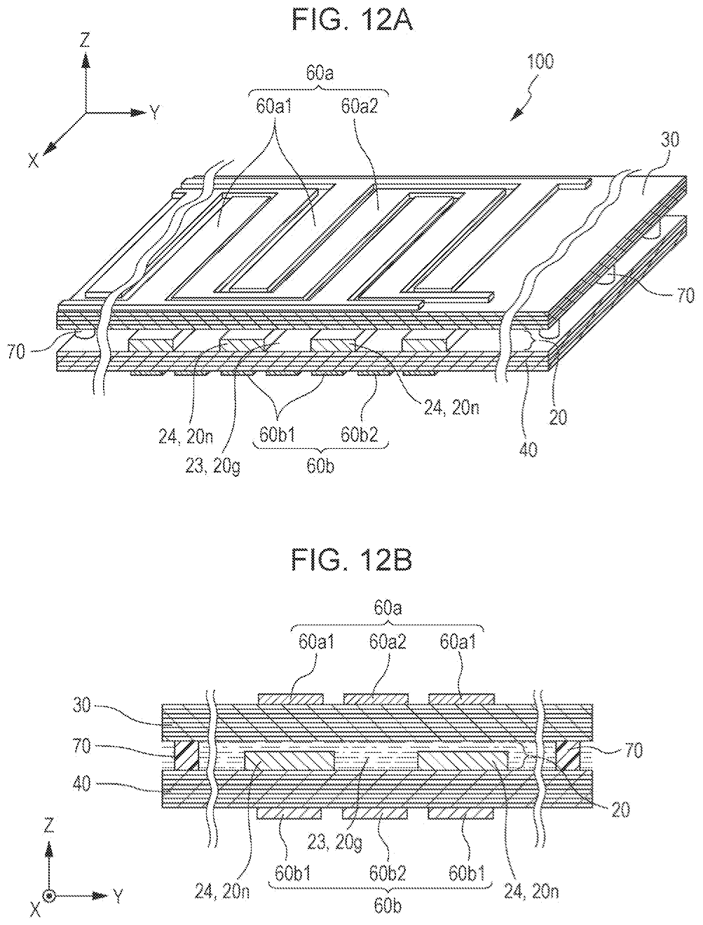

FIG. 12A is a perspective view of an optical device 100 according to an exemplary embodiment of the present disclosure. FIG. 12B is a cross-sectional view of the optical device 100 shown in FIG. 12A as taken along the Y-Z plane. For simplicity, FIGS. 12A and 12B show part of the optical device 100.

In the example shown in FIGS. 12A and 12B, unlike in the example shown in Embodiment 3, the plurality of electrodes of the electrode layer 60b include a plurality of first electrodes 60b1 and one or more second electrodes 60b2 as is the case with the electrode layer 60a. Any voltages can be independently applied to each of the plurality of electrodes of the electrode layer 60a and each of the plurality of electrodes of the electrode 60b. In the example shown in FIGS. 12A and 12B, voltages of two different values are alternately applied or voltages of the same value are applied to the plurality of first electrodes 60a1 of the electrode layer 60a. The same applies to the plurality of electrodes of the electrode layer 60b.

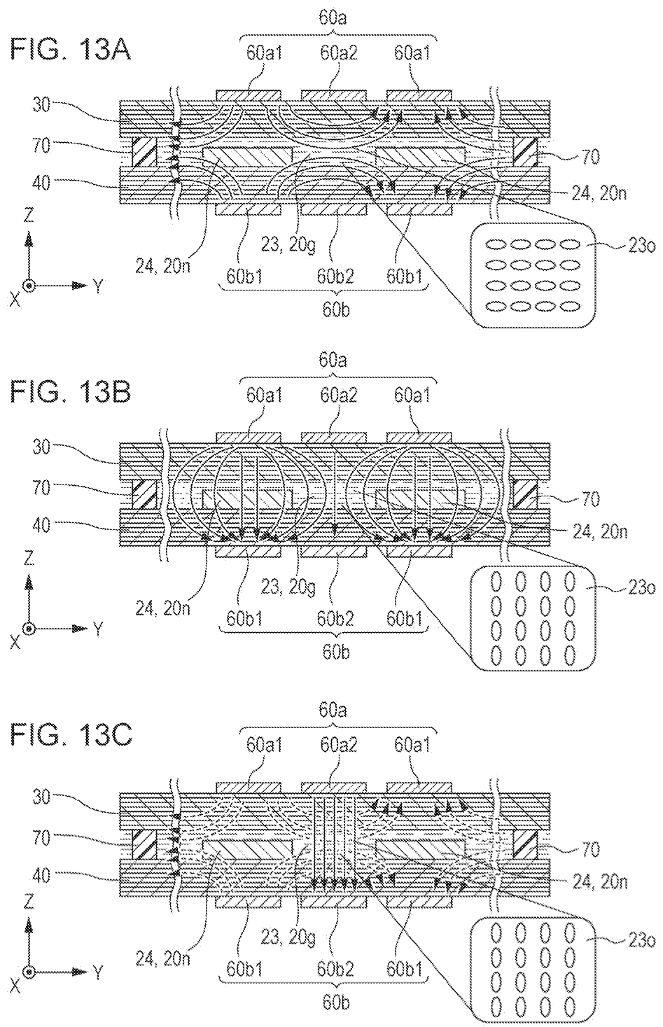

Next, orientational control of a liquid crystal material 23 according to the present embodiment is described with reference to FIGS. 13A and 13B.

FIG. 13A is a diagram schematically showing a first state in which the liquid crystal material 23 is oriented in the Y direction in the example shown in FIG. 12B. FIGS. 13B and 13C are each a diagram schematically showing a second state in which the liquid crystal material 23 is oriented in the Z direction in the example shown in FIG. 12B. The orientation direction of the liquid crystal material 23 sandwiched between the mirror 30 and the mirror 40 is controlled by an electric field that is formed by voltages applied to the plurality of first electrodes 60a1 and the one or more second electrodes 60a2 of the electrode layer 60a and the plurality of first electrodes 60b1 and the one or more second electrodes 60b2 of the electrode layer 60b.

In the example shown in FIG. 13A, a potential difference is provided between any adjacent two of the plurality of first electrodes 60a1 of the electrode layer 60a, and the one or more second electrodes 60a2 of the electrode layer 60a are electrically open. The same applies to the plurality of first electrodes 60b1 and the one or more second electrodes 60b2 of the electrode layer 60b. In this state, as shown in FIG. 13A, the potential difference produced between the two adjacent electrodes causes lines of electric force substantially parallel with the Y direction to appear in the one or more optical waveguide areas 20g. This causes the liquid crystal material 23 contained in the one or more optical waveguide areas 20g to be oriented in the Y direction.

In the example shown in FIG. 13B, the plurality of first electrodes 60a1 and the one or more second electrodes 60a2 of the electrode layer 60a are at substantially the same potential, and the plurality of first electrodes 60b1 and the one or more second electrodes 60b2 of the electrode layer 60b are at substantially the same potential, with a potential difference provided between the plurality of first electrodes 60a1 and the one or more second electrodes 60a2 of the electrode layer 60a and the plurality of first electrodes 60b1 and the one or more second electrodes 60b2 of the electrode layer 60b. In this state, as shown in FIG. 13B, lines of electric force substantially parallel with the Z direction appear from the mirror 30 toward the mirror 40. This causes the liquid crystal material 23 contained in the one or more optical waveguide areas 20g to be oriented in the Z direction. Although, in the example shown in FIG. 13B, the lines of electric force appear from the mirror 30 toward the mirror 40, the opposite may be true.

In the example shown in FIG. 13C, a first potential difference is provided between any adjacent two of the plurality of first electrodes 60a1 of the electrode layer 60a and between any adjacent two of the plurality of first electrodes 60b1 of the electrode layer 60b, and a second potential difference is provided between the one or more second electrodes 60a2 of the electrode layer 60a and the one or more second electrodes 60b2 of the electrode layer 60b. The first potential difference may be smaller than the potential difference in the example shown in FIG. 13A, and may be smaller than the second potential difference. In this state, as shown in FIG. 13C, lines of electric force substantially parallel with the Z direction appear from the mirror 30 toward the mirror 40. This causes the liquid crystal material 23 contained in the one or more optical waveguide areas 20g to be oriented in the Z direction. Although, in the example shown in FIG. 13C, the lines of electric force appear from the mirror 30 toward the mirror 40, the opposite may be true. The state shown in FIG. 13C too can be said to be the second state in which the liquid crystal material 23 contained in the one or more optical waveguide areas 20g is oriented in the Z direction by an electric field that is generated between the one or more second electrodes 60a2 of the electrode layer 60a and the one or more second electrodes 60b2 of the electrode layer 60b.

By thus applying voltages to the plurality of first electrodes 60a1 and the one or more second electrodes 60a2 of the electrode layer 60a and the plurality of first electrodes 60b1 and the one or more second electrodes 60b2 of the electrode layer 60b, the first state shown in FIG. 13A and the second state shown in FIGS. 13B and 13C can be arbitrarily created. The first state and the second state differ from each other in refractive index of the liquid crystal material 23 contained in the one or more optical waveguide areas 20g. In the process of a transition from the first state to the second state and a transition from the second state to the first state, the refractive index of the liquid crystal material 23 continuously changes. This entails a change in angle of emission of light that is emitted from the mirror 30. As a result, an optical scan can be achieved.

The width of each first electrode 60a1 of the electrode layer 60a in the Y direction and/or the width of each first electrode 60b1 of the electrode layer 60b in the Y direction may be narrower than the width of each non-waveguide area 20n in the Y direction. This causes the lines of electric force formed in the one or more optical waveguide areas 20g to be more parallel with the Y direction in the first state shown in FIG. 13A.

### Embodiment 5

The following description omits to describe configurations which are the same as those of the examples shown in Embodiment 1.

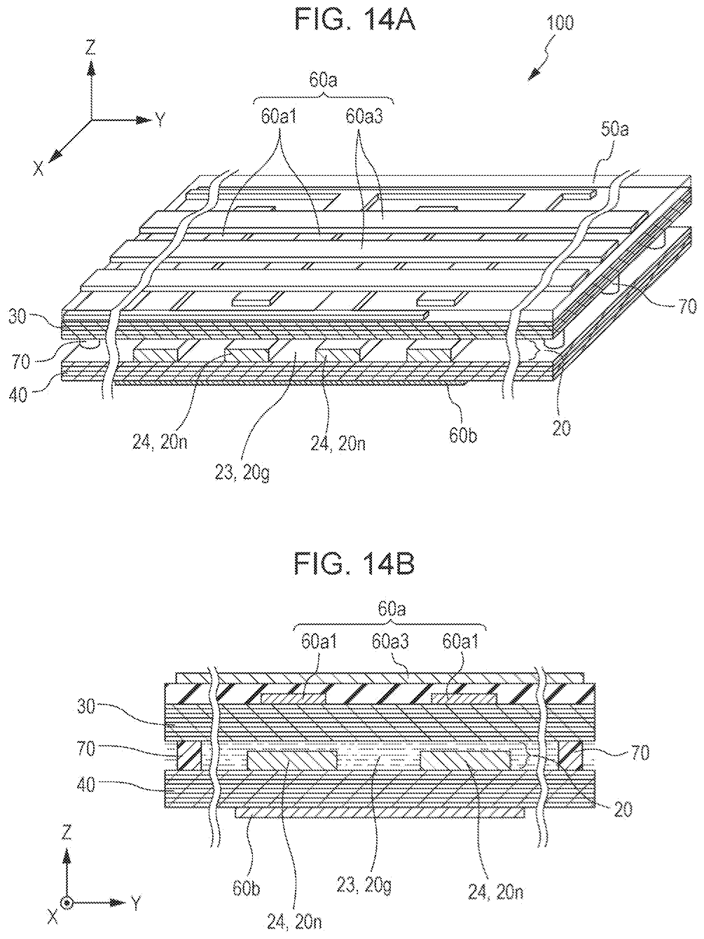

FIG. 14A is a perspective view of an optical device 100 according to an exemplary embodiment of the present disclosure. FIG. 14B is a cross-sectional view of the optical device 100 shown in FIG. 14A as taken along the Y-Z plane. For simplicity, FIGS. 14A and 14B show part of the optical device 100.

In the example shown in FIGS. 14A and 14B, unlike in the example shown in Embodiment 1, the plurality of electrodes of the electrode layer 60a include a plurality of first electrodes 60a1 and a plurality of third electrodes 60a3. The plurality of first electrodes 60a1 are equivalent to the plurality of electrodes of the electrode layer 60a shown in FIGS. 6A and 6B. The plurality of third electrodes 60a3 are substantially orthogonal to the plurality of first electrodes 60a1. In order to insulate the plurality of first electrodes 60a1 and the plurality of third electrodes 60a3 from each other, an insulating layer 50a is located between the plurality of first electrodes 60a1 and the plurality of third electrodes 60a3. Any voltages can be independently applied to each of the plurality of electrodes of the electrode layer 60a and the single electrode of the electrode 60b. In the example shown in FIGS. 14A and 14B, voltages of two different values are alternately applied or voltages of the same value are applied to the plurality of first electrodes 60a1 of the electrode layer 60a. Voltages of two different values are alternately applied or voltages of the same value are applied to the plurality of third electrodes 60a3 of the electrode layer 60a, too.

Alternately applying voltages of two different values to the plurality of first electrodes 60a1 of the electrode layer 60a enables orientational control of the liquid crystal material 23 in the Y direction. Alternately applying voltages of two different values to the plurality of third electrodes 60a3 of the electrode layer 60a enables orientational control of the liquid crystal material 23 in the X direction. That is, the plurality of first electrodes 60a1 and the plurality of third electrode 60a3 of the electrode layer 60a enable orientational control of the liquid crystal material 23 in any direction in an X-Y plane. Of course, providing a potential difference between the plurality of first electrodes 60a1 and the plurality of third electrodes 60a3 of the electrode layer 60a and the single electrode of the electrode layer 60b makes it possible to orient the liquid crystal material 23 in an orientation direction along the Z direction.

he width of each first electrode 60a1 of the electrode layer 60a in the Y direction may be narrower than the width of each non-waveguide area 20n in the Y direction. This causes the lines of electric force formed in the one or more optical waveguide areas 20g to be more parallel with the Y direction. Similarly, the width of each third electrode 60a3 of the electrode layer 60a in the X direction may be as narrow as the width of each first electrode 60a1 of the electrode layer 60a in the Y direction. This causes the lines of electric force formed in the one or more optical waveguide areas 20g to be more parallel with the X direction.

### Embodiment 6

The following description omits to describe configurations which are the same as those of the examples shown in Embodiment 5.

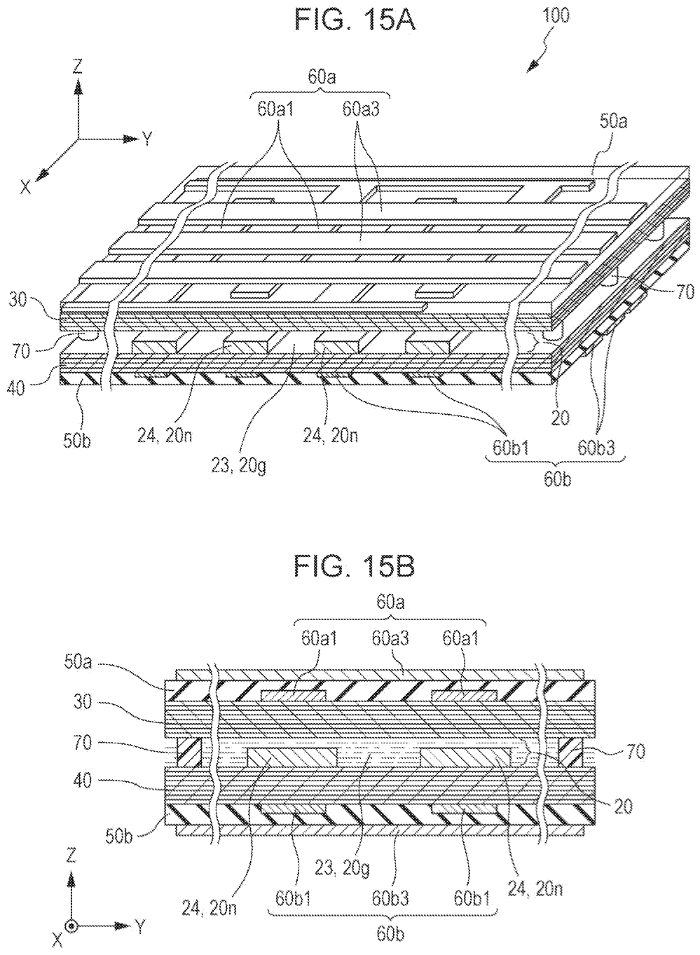

FIG. 15A is a perspective view of an optical device 100 according to an exemplary embodiment of the present disclosure. FIG. 15B is a cross-sectional view of the optical device 100 shown in FIG. 15A as taken along the Y-Z plane. For simplicity, FIGS. 15A and 15B show part of the optical device 100.

In the example shown in FIGS. 15A and 15B, unlike in the example shown in Embodiment 5, the plurality of electrodes of the electrode layer 60b include a plurality of first electrodes 60b1 and a plurality of third electrodes 60b3 as is the case with the electrode layer 60a. In order to insulate the plurality of first electrodes 60b1 and the plurality of third electrodes 60b3 from each other, an insulating layer 50b is located between the plurality of first electrodes 60b1 and the plurality of third electrodes 60b3. Any voltages can be independently applied to each of the plurality of electrodes of the electrode layer 60a and each of the plurality of electrodes of the electrode layer 60b. In the example shown in FIGS. 15A and 15B, voltages of two different values are alternately applied or voltages of the same value are applied to the plurality of first electrodes 60a1 of the electrode layer 60a. Voltages of two different values are alternately applied or voltages of the same value are applied to the plurality of third electrodes 60a3 of the electrode layer 60a, too. Voltages of two different values are alternately applied or voltages of the same value are applied to the plurality of first electrodes 60b1 of the electrode layer 60b, too. Voltages of two different values are alternately applied or voltages of the same value are applied to the plurality of third electrodes 60b3 of the electrode layer 60b, too.

Alternately applying voltages of two different values to the plurality of first electrodes 60a1 of the electrode layer 60a and/or alternately applying voltages of two different values to the plurality of first electrodes 60b1 of the electrode layer 60b enable(s) orientational control of the liquid crystal material 23 in the Y direction. Alternately applying voltages of two different values to the plurality of third electrodes 60a3 of the electrode layer 60a and/or alternately applying voltages of two different values to the plurality of third electrodes 60b3 of the electrode layer 60b enable(s) orientational control of the liquid crystal material 23 in the X direction. That is, the plurality of first electrodes 60a1 and the plurality of third electrodes 60a3 of the electrode layer 60a and the plurality of first electrodes 60b1 and the plurality of third electrodes 60b3 of the electrode layer 60b enable orientational control of the liquid crystal material 23 in any direction in the X-Y plane. Of course, providing a potential difference between the plurality of first electrodes 60a1 and the plurality of third electrodes 60a3 of the electrode layer 60a and the plurality of first electrodes 60b1 and the plurality of third electrodes 60b3 of the electrode layer 60b makes it possible to orient the liquid crystal material 23 in an orientation direction along the Z direction.

The width of each first electrode 60a1 of the electrode layer 60a in the Y direction and/or the width of each first electrode 60b1 of the electrode layer 60b in the Y direction may be narrower than the width of each non-waveguide area 20n in the Y direction. This causes the lines of electric force formed in the one or more optical waveguide areas 20g to be more parallel with the Y direction. Similarly, the width of each third electrode 60a3 of the electrode layer 60a in the X direction and/or the width of each third electrode 60b3 of the electrode layer 60b in the X direction may be as narrow as the width of each first electrode 60a1 of the electrode layer 60a in the Y direction and/or the width of each first electrode 60b1 of the electrode layer 60b in the Y direction. This causes the lines of electric force formed in the one or more optical waveguide areas 20g to be more parallel with the X direction.

Next, the effects of the optical devices 100 according to Embodiments 1 to 6 are described.

In a case where the width of each of the one or more optical waveguide areas 20g in the Y direction is wide, the aforementioned conventional alignment process makes it possible to determine the initial orientation direction of the liquid crystal material 23. However, in a case where the one or more optical waveguide areas 20g include an optical waveguide area with a width less than or equal to 5 μm in the Y direction, it is not easy to determine the initial orientation direction of the liquid crystal material 23 with the conventional alignment process. Even in such a case, the arrangement of electrodes in Embodiments 1 to 6 brings about an effect of enabling orientational control of the liquid crystal material 23 in any direction in the Y-Z plane, in the X-Y plane, or in an X-Y-Z space.

### Example 1

In Example 1, the orientational state of the liquid crystal material 23 was confirmed through the optical device 100 described in Embodiment 1. The mirrors 30 and 40 used were dielectric multilayer mirrors produced by alternately stacking dielectric layers of Nb₂O₅ and SiO₂. The mirror 30 is higher in translucency than the mirror 40. The mirrors 30 and 40 were designed to have normal incidence reflectivities of 99.6% and 99.9%, respectively, in response to light with a wavelength of 940 nm. The plurality of dielectric members 24 were formed from SiO₂. The height and width of each of the plurality of dielectric members 24 in the Z direction and the Y direction were approximately 1 μm and approximately 30 μm, respectively. The plurality of dielectric members 24 were placed at equal spacings along the Y direction. The width of each of the one or more optical waveguide areas 20g in the Y direction was approximately 5 μm. An electrode pattern formed from ITO was provided on the mirror 30 by a photolithographic technique. The widths of the plurality of electrodes of the electrode layer 60a in the Y direction were narrower than the widths of the plurality of non-waveguide areas 20n in the Y direction, respectively. The width of each of the plurality of electrodes of the electrode layer 60a in the Y direction was approximately 20 μm. The length of the plurality of electrodes of the electrode layer 60a in the X direction was substantially equal to the length of the one or more optical waveguide areas 20g in the X direction. The one or more optical waveguide areas 20g were arranged in an array. The plurality of electrodes of the electrode layer 60a were formed from two comb-like electrodes disposed so as to mesh with each other. The plurality of electrodes were provided so as to overlap the plurality of non-waveguide areas 20n, respectively, when seen from an angle parallel with the Z direction. The single electrode of the electrode layer 60b was provided by forming a film of ITO on the mirror 40.

Although not shown in FIGS. 6A and 6B, the optical device 100 was provided on a quartz substrate with a thickness of 0.625 μm. The single electrode of the electrode layer 60b was provided on the quartz substrate, a dielectric multilayer film was provided as the mirror 40 on the single electrode, and the plurality of dielectric members 24 and the supporting members 70, which were formed from resin, were provided on the mirror 40. The mirror 30 and the mirror 40 were provided by being bonded together via the supporting members 70. The height of the supporting members 70 in the Z direction is approximately 2 μm. Although not shown in FIGS. 6A and 6B, a UV-curable adhesive was applied between the mirror 30 and the mirror 40 so as to surround an area in which the liquid crystal material 23 is sealed. The mirror 30 and the mirror 40 were bonded together by irradiating the adhesive with ultraviolet radiation. The liquid crystal material 23 was vacuum-injected through some open areas in the adhesive. The liquid crystal material 23 used was a material called “BK7”. The liquid crystal material 23 was sealed in by applying an adhesive to the open areas after injecting the liquid crystal material 23. The control circuit (not illustrated) was connected via electrical wires to the plurality of electrodes of the electrode layers 60a and the single electrode of the electrode layer 60b. This makes it possible to individually feed voltages to the plurality of electrodes of the electrode layers 60a and the single electrode of the electrode layer 60b.

The orientational state of the liquid crystal material 23 was confirmed in the following manner. In a polarizing microscope, the optical device 100 was placed between two crossed-Nicols polarizing plates so as to be parallel to the two polarizing plates. With reference to the direction of polarization of light passing through the light-entrance-side polarizing plate, the optical device 100 was placed in the microscope with its optical waveguide direction rotated 45 degrees in a plane parallel to the two polarizing plates. Light having passed through the optical device 100 can be observed as an image by the microscope through the light-exit-side polarizing plate.

The first state described with reference to FIG. 7A was confirmed. The plurality of electrodes of the electrode layer 60a were alternately set to a potential difference of 10 V. The single electrode of the electrode layer 60b is electrically open. In this state, the liquid crystal material 23 is oriented in the Y direction. That is, the direction of polarization of light having passed through the optical device 100 after having passed through the entrance-side polarizing plate is inclined at 45 degrees. This causes a portion of the light having passed through the optical device 100 to pass through the exit-side polarizing plate. As a result, a bright image was observed by the polarizing microscope.

Next, the second state described with reference to FIG. 7B was confirmed. Voltages of the same value were applied to the plurality of electrodes of the electrode layer 60a, and a potential difference of 10 V was provided between the plurality of electrodes of the electrode layer 60a and the single electrode of the electrode layer 60b. In this state, the liquid crystal material 23 is oriented in the Z direction. This causes light having passed through the optical device 100 after having passed through the entrance-side polarizing plate to arrive at the exit-side polarizing plate while maintaining its direction of polarization. Since the two polarizing plates are in a crossed-Nicols arrangement, the light having passed through the optical device 100 cannot pass through the exit-side polarizing plate. As a result, a dark image was observed by the microscope. It was confirmed that switching between the first state and the second state brings about a light-dark change in the one or more optical waveguide areas 20g.

### Example 2

In Example 2, the orientational state of the liquid crystal material 23 was confirmed through the optical device 100 described in Embodiment 2. In Example 2, unlike in Example 1, the electrode layer 60b includes a plurality of electrodes. The plurality of electrodes of the electrode layer 60b were designed in a manner which is similar to that in which the plurality of electrodes of the electrode layer 60a were designed.

The orientational state of the liquid crystal material 23 was confirmed in the manner described in Example 1.

The first state described with reference to FIG. 9A was confirmed. The plurality of electrodes of the electrode layer 60a were alternately set to a potential difference of 10 V, and similarly, the plurality of electrodes of the electrode layer 60b were alternately set to a potential difference of 10 V. At that time, a bright image was observed by the polarizing microscope.

Next, the second state described with reference to FIG. 9B was confirmed. Voltages of the same value were applied to the plurality of electrodes of the electrode layer 60a, and voltages of the same value were applied to the plurality of electrodes of the electrode layer 60b, with a potential difference of 10 V provided between the plurality of electrodes of the electrode layer 60a and the plurality of electrodes of the electrode layer 60b. At that time, a dark image was observed by the polarizing microscope.

Accordingly, it was confirmed that in the first state, the liquid crystal material 23 is oriented along the Y direction and that in the second state, the liquid crystal material 23 is oriented along the Z direction.

### Example 3

In Example 3, the orientational state of the liquid crystal material 23 was confirmed through the optical device 100 described in Embodiment 3. In Example 3, in addition to Example 1, a third electrode was provided in gaps between the two comb-like electrodes in the electrode layer 60a. The two comb-like electrodes are equivalent to the plurality of first electrodes 60a1 shown in FIGS. 10A and 10B, and the third electrode is equivalent to the one or more second electrodes 60a2 shown in FIGS. 10A and 10B. One or more portions of the third electrode extending in the X direction overlap at least parts of the one or more optical waveguide areas 20g, respectively, when seen from an angle parallel with the Z direction. The one or more portions were made narrower than 5 μm, which is the width of each of the one or more optical waveguide areas 20g in the Y direction. The width of each of the plurality of portions in the Y direction was 3 μm.

The orientational state of the liquid crystal material 23 was confirmed in the manner described in Example 1.

The first state described with reference to FIG. 11A was confirmed. The plurality of first electrodes 60a1 of the electrode layer 60a were alternately set to a potential difference of 10 V. The one or more second electrodes 60a2 of the electrode layer 60a and the single electrode of the electrode layer 60b are electrically open. At that time, a bright image was observed by the polarizing microscope.

Next, the second state described with reference to FIG. 11B was confirmed. Voltages of the same value were applied to the plurality of first electrodes 60a1 and the one or more second electrodes 60a2 of the electrode layer 60a, and a potential difference of 10 V was provided between the plurality of first electrodes 60a1 and the one or more second electrodes 60a2 of the electrode layer 60a and the single electrode of the electrode layer 60b. At that time, a dark image was observed by the polarizing microscope.

Next, after returning to the first state described with reference to FIG. 11A, the second state described with reference to FIG. 11C was confirmed. At substantially the same time as a reduction from 10 V to 1 V in the potential difference alternately provided to the plurality of first electrodes 60a1 of the electrode layer 60a, a potential difference of 9.5 V was provided between the one or more second electrodes 60a2 of the electrode layer 60a and the single electrode of the electrode layer 60b. This state is achieved, for example, in the following manner: (1) Voltages of 10 V and 9 V are applied to any adjacent two, respectively, of the plurality of first electrodes 60a1 of the electrode layer 60a; (2) a voltage of 9.5 V is applied to the one or more second electrodes 60a2 of the electrode layer 60a; and (3) a voltage of 0 V is applied to the single electrode of the electrode layer 60b. In this state, too, a dark image was observed by the polarizing microscope. Accordingly, neither the configuration shown in FIG. 11B nor the configuration shown in FIG. 11C has any problem in achieving the second state.

### Example 4

In Example 4, the orientational state of the liquid crystal material 23 was confirmed through the optical device 100 described in Embodiment 4. In Example 4, unlike in Example 3, the plurality of electrodes of the electrode layer 60b include a plurality of first electrodes 60b1 and one or more second electrodes 60b2 as is the case with the electrode layer 60a. The plurality of first electrodes 60b1 and the one or more second electrodes 60b2 of the electrode layer 60b were designed in a manner which is similar to that in which the plurality of first electrodes 60a1 and the one or more second electrodes 60a2 of the electrode layer 60a were designed.

The orientational state of the liquid crystal material 23 was confirmed in the manner described in Example 1.

The first state described with reference to FIG. 13A was confirmed. The plurality of first electrodes 60a1 of the electrode layer 60a were alternately set to a potential difference of 10 V, and the plurality of first electrodes 60b1 of the electrode layer 60b were alternately set to a potential difference of 10 V. The one or more second electrodes 60a2 of the electrode layer 60a and the one or more second electrodes 60b2 of the electrode layer 60b are electrically open. At that time, a bright image was observed by the polarizing microscope.

Next, the second state described with reference to FIG. 13B was confirmed. Voltages of the same value were applied to the plurality of first electrodes 60a1 and the one or more second electrodes 60a2 of the electrode layer 60a, and voltages of the same value were applied to the plurality of first electrodes 60b1 and the one or more second electrodes 60b2 of the electrode layer 60b, with a potential difference of 10 V provided between the plurality of first electrodes 60a1 and the one or more second electrodes 60a2 of the electrode layer 60a and the plurality of first electrodes 60b1 and the one or more second electrodes 60b2 of the electrode layer 60b. At that time, a dark image was observed by the polarizing microscope.

Next, after returning to the first state described with reference to FIG. 13A, the second state described with reference to FIG. 13C was confirmed. At substantially the same time as a reduction from 10 V to 1 V in the potential difference alternately provided to the plurality of first electrodes 60a1 of the electrode layer 60a and the potential difference alternately provided to the plurality of first electrodes 60b1 of the electrode layer 60b, a potential difference of 9.5 V was provided between the one or more second electrodes 60a2 of the electrode layer 60a and the one or more second electrodes 60b2 of the electrode layer 60b. This state is achieved, for example, in the following manner: (1) Voltages of 10 V and 9 V are applied to any adjacent two, respectively, of the plurality of first electrodes 60a1 of the electrode layer 60a; (2) a voltage of 9.5 V is applied to the one or more second electrodes 60a2 of the electrode layer 60a; (3) voltages of 0.5 V and −0.5 V are applied to two of the plurality of first electrodes 60b1 facing the two electrodes of the electrode layer 60a to which the voltages of 10 V and 9 V were applied, respectively; and (4) a voltage of 0 V is applied to the one or more second electrode 60b2 of the electrode layer 60b. In this state, too, a dark image was observed by the polarizing microscope. Accordingly, neither the configuration shown in FIG. 13B nor the configuration shown in FIG. 13C has any problem in achieving the second state.

### Example 5

Example 5 describes specific configurations of the optical devices 100 described in Embodiments 5 and 6. In Example 5, in addition to Example 1, the insulating layer 50a was formed from SiO₂ on the plurality of first electrodes 60a1. The thickness of the insulating layer 50a in the Z direction is approximately 200 μm. The plurality of third electrodes 60a3 were provided on the insulating layer 50a so as to be substantially orthogonal to the plurality of first electrodes 60a1. The width of each of the plurality of first electrodes 60a1 and the plurality of third electrodes 60a3 of the electrode layer 60a was approximately 20 μm, and the spacing between any two adjacent electrodes was approximately 50 μm. Although FIG. 14A shows only three electrodes as the plurality of third electrodes 60a3, the number of the plurality of third electrodes 60a3 may be increased as is the case with adjusting the length of the one or more optical waveguide areas 20g in the X direction. Further, the width of each of the electrodes and the spacing between electrodes may be different from those of Example 5.

Alternately applying voltages of two different values to the plurality of third electrodes 60a3 of the electrode layer 60a makes it possible to cause the liquid crystal material 23 contained in the one or more optical waveguide areas 20g to be oriented in the X direction parallel with the optical waveguide direction. Alternatively, voltages may be applied to the plurality of third electrodes 60a3 of the electrode layer 60a so that there is a sequential increase or decrease in voltage along the X direction. Further, alternately applying voltages of two different values to the plurality of first electrodes 60a1 of the electrode layer 60a makes it possible to cause the liquid crystal material 23 contained in the one or more optical waveguide areas 20g to be oriented in the Y direction parallel with the optical waveguide direction. Alternatively, voltages may be applied to the plurality of first electrodes 60a1 of the electrode layer 60a so that there is a sequential increase or decrease in voltage along the Y direction. It is also possible to orient the liquid crystal material 23 in any direction in the X-Y plane by simultaneously applying the aforementioned voltages to the plurality of first electrodes 60a1 and the plurality of third electrodes 60a3 of the electrode layer 60a.

Meanwhile, in the optical device 100 described in Embodiment 6, the plurality of electrodes of the electrode layer 60b include a plurality of first electrodes 60b1 and a plurality of third electrodes 60b3 as is the case with the electrode layer 60a. Applying voltages separately to each of the plurality of electrodes of both the electrode layer 60a and the electrode layer 60b makes it possible to more easily control the orientation of the liquid crystal material 23.

An optical device according to an embodiment of the present disclosure are applicable, for example, to a use such as a LiDAR system that is mounted on a vehicle such as an automobile, a UAV, or an AGV.

What is claimed is:

1. An optical device comprising:
a first mirror having translucency and including a first reflecting surface extending along a first direction and a second direction intersecting the first direction;
a second mirror including a second reflecting surface facing the first reflecting surface;
an optical waveguide layer located between the first mirror and the second mirror, the optical waveguide layer including a plurality of non-waveguide areas laid side-by-side along the second direction and one or more optical waveguide areas located between the plurality of non-waveguide areas, the optical waveguide areas containing a liquid crystal material and propagating light along the first direction; and
two electrode layers facing each other across the optical waveguide layer, at least one of the two electrode layers including a plurality of electrodes laid side-by-side along the second direction,
wherein the plurality of electrodes include an electrode overlapping at least a part of the plurality of non-waveguide areas when seen from an angle parallel with a direction perpendicular to the first reflecting surface or the second reflecting surface.

2. The optical device according to claim 1, further comprising a control circuit connected to each of the plurality of electrodes included in the two electrode layers,
wherein the control circuit executes, during operation, at least either a first operation of providing a potential difference between at least a part of the plurality of electrodes and at least another part of the plurality of electrodes or a second operation of providing a potential difference between an electrode included in one of the two electrode layers and an electrode included in the other of the two electrode layers.

3. The optical device according to claim 1, wherein
one of the two electrode layers is located between the optical waveguide layer and the first reflecting surface, inside the first mirror, or on a surface of the first mirror opposite to the first reflecting surface, and
the other of the two electrode layers is located between the optical waveguide layer and the second reflecting surface, inside the second mirror, or on a surface of the second mirror opposite to the second reflecting surface.

4. The optical device according to claim 1, wherein the one or more optical waveguide areas include an optical waveguide area whose width in the second direction is less than or equal to 5 μm.

5. The optical device according to claim 1, further comprising a control circuit connected to each electrode included in the two electrode layers,
wherein
the plurality of electrodes overlap at least parts of the plurality of non-waveguide areas, respectively, when seen from an angle parallel with a direction perpendicular to the first reflecting surface or the second reflecting surface, and
the control circuit executes, during operation, at least either a first operation of providing a potential difference between any adjacent two of the plurality of electrodes and a second operation of providing a potential difference between an electrode included in one of the two electrode layers and an electrode included in the other of the two electrode layers.

6. The optical device according to claim 1, wherein the plurality of electrodes include a plurality of first electrodes overlapping at least parts of the plurality of non-waveguide areas, respectively, when seen from an angle parallel with a direction perpendicular to the first reflecting surface or the second reflecting surface and one or more second electrodes overlapping at least parts of the one or more optical waveguide areas, respectively, when seen from an angle parallel with the direction perpendicular to the first reflecting surface or the second reflecting surface.

7. The optical device according to claim 1, further comprising a control circuit connected to each electrode included in the two electrode layers,
wherein
the plurality of electrodes include a plurality of first electrodes overlapping at least parts of the plurality of non-waveguide areas, respectively, when seen from an angle parallel with a direction perpendicular to the first reflecting surface or the second reflecting surface and one or more second electrodes overlapping at least parts of the one or more optical waveguide areas, respectively, when seen from an angle parallel with the direction perpendicular to the first reflecting surface or the second reflecting surface, and
the control circuit executes, during operation, at least either a first operation of providing a potential difference between any adjacent two of the plurality of first electrodes and a second operation of providing a potential difference between an electrode included in one of the two electrode layers and an electrode included in the other of the two electrode layers.

8. The optical device according to claim 1, wherein
one of the two electrode layers includes the plurality of electrodes, and
the other of the two electrode layers includes a single electrode.

9. The optical device according to claim 1, wherein both of the two electrode layers include the plurality of electrodes.

10. The optical device according to claim 1, wherein
the plurality of non-waveguide areas include first and second non-waveguide areas adjacent to each other,
the plurality of electrodes include two first electrodes adjacent to each other,
one of the two first electrodes and the first non-waveguide area at least partially overlap each other when seen from an angle parallel with a direction perpendicular to the first reflecting surface or the second reflecting surface, and
the other of the two first electrodes and the second non-waveguide area at least partially overlap each other when seen from an angle parallel with the direction perpendicular to the first reflecting surface or the second reflecting surface.
